(19) United States
(12) Patent Application Publication
(10) Pub. No.: US 2011/0267452 A1
(43) Pub. Date: Nov. 3, 2011

(54) IMAGE COMPRESSING APPARATUS, IMAGE COMPRESSING METHOD AND VEHICLE-MOUNTED IMAGE RECORDING APPARATUS

(75) Inventors: Takuma Notsu, Osaka (JP); Masahiro Ogawa, Osaka (JP)

(73) Assignee: Panasonic Corporation, Osaka (JP)

(21) Appl. No.: 13/183,802

(22) Filed: Jul. 15, 2011

Related U.S. Application Data
(63) Continuation of application No. PCT/JP2009/007164, filed on Dec. 24, 2009.

(30) Foreign Application Priority Data
Feb. 20, 2009 (JP) 2009-037947

(51) Int. Cl. G06K 9/00; H04N 7/18

(52) U.S. Cl. 348/116; 382/104; 348/E07.085

(57) ABSTRACT

A road shape recognition device checks a position of a currently travelling vehicle detected by a position detection device with map information so that a road shape at each travelling spot of the currently travelling vehicle is recognized. An image division device divides a display screen of surrounding image data of the currently travelling vehicle into a plurality of divided regions depending on the road shape and sets a data compression rate suitable for the road shape in each of the plurality of divided regions. An image compression device compresses the surrounding image data in each of the plurality of divided regions into codes based on the data compression rate set for each of the divided regions.

### FIELD OF THE INVENTION

The present invention relates to, an image compressing apparatus and an image compressing method developed for a vehicle-mounted camera, and a vehicle-mounted image recording apparatus, more particularly to a technology for dissolving the relationship of trade-off between an image quality and recording time by adaptively controlling a data compression rate and a frame rate applied to an image depending on road conditions and driving conditions.

### BACKGROUND OF THE INVENTION

Drive recorders mounted in vehicles available in recent years can record images of a traffic accident including images at the moment of impact and before and after the accident. A drive recorder of this type temporarily record of information of images photographed by a CCD camera and then compressed and data collected from sensors such as an acceleration sensor in a random access memory in an up-to-the-minute manner. As soon as an impact sensor is put into action in response to the occurrence of an accident, the drive recorder transfers the latest recorded information immediately before the impact stored in the random access memory to a flash memory. Then, the compressed image information thus recorded in the flash memory is decompressed so that the images immediately before the accident are reproduced alongside the sensor data and used to analyze the accident.

To analyze facts of the accident, it is necessary to obtain images having a good image quality. When the image data compression rate is lowered to improve the image quality, however, a compression coding amount increases, making it difficult to record the images over a long period of time.

The Patent Document 1 discloses an invention wherein a frame rate and a data compression rate are changed in images captured in multiple directions based on operation mode, audio information, motion information of a targeted object, time when the object is found, and positional information of a vehicle equipped with the invented technology so that an image quality is improved in parts of significance in the images but remains unchanged in any other parts which are less significant.

The Patent Document 2 discloses an invention wherein a frame rate and a degree of resolution are set based on whether there is any object identified in an image recognition result, distance to the object, travelling speed of the object, travelling direction of the object, speed of a vehicle equipped with the invented technology, and positional information of the vehicle so that an image quality is adjusted depending on current circumstances of the vehicle.

### PRIOR ART DOCUMENT

### Patent Document

Patent Document 1: Unexamined Japanese Patent Applications Laid-Open No. 2003-274358
Patent Document 2: Unexamined Japanese Patent Applications Laid-Open No. 2007-172035

### SUMMARY OF THE INVENTION

### Problem to be Solved by the Invention

According to the invention disclosed in the Patent Document 1 wherein the data compression rates for all of frames are collectively controlled, a significant part and a less significant part in a display screen have the same data compression rate. When the data compression rate is lowered to improve the image quality of the significant part, the image quality of any other less significant parts is unnecessarily increased. As a result, an overall compression coding amount increases, which is an overriding disadvantage in long-hour recording. On the other hand, when the data compression rate is increased to enable the long-hour recording, the image quality of any significant parts deteriorates, possibly resulting in a poor visibility of a photographic subject to be visually confirmed. Thus, there is conventionally an unsolved problem of trade-off between the image quality and the recording time.

According to the invention disclosed in the Patent Document 2, the vehicle speed information and the vehicle positional information are used to control the image quality. However, such information is not useful under the circumstances where road conditions or driving conditions instantly change. When a vehicle suddenly starts, for example, the vehicle may be still running slow but a high acceleration is applied to the vehicle, suggesting the possibility of collision into another vehicle travelling ahead of the vehicle. When a vehicle is about to collide into another vehicle travelling ahead of the vehicle and then jerks to a halt, the vehicle is subjected to an excessive acceleration. If a vehicle failing to negotiate a sharp curve is almost steered off a traffic lane, the vehicle is subjected to an excessive acceleration in lateral direction. The invention fails to manage such situations as sudden start, sudden stop, and sharp curve that might lead to a traffic accident. Though the image quality is controlled in high accident spots based on the vehicle positional information, the invention still does not address situations with a high potential for accidents, for example, when the vehicle is travelling on an unfamiliar road.

The present invention was accomplished to solve the technical problems of the prior art described so far. A main object of the present invention is to enable long-hour recording while ensuring a high image quality of images used to analyze an accident, thereby dissolving the relationship of trade-off between the image quality and recording time. According to the present invention, images can be recorded with different image qualities suitable for a lot of different situations.

### Means for Solving the Problem

1) An image compressing apparatus according to the present invention comprises:

a position detection device configured to detect a position of a currently travelling vehicle equipped with the apparatus;

a road shape recognition device configured to check the position of the currently travelling vehicle detected by the position detection device with a map information so that a road shape at each travelling spot of the currently travelling vehicle is recognized;

an image division device configured to divide a display screen of surrounding image data of the currently travelling vehicle into a plurality of divided regions depending on the road shape and set a data compression rate suitable for the road shape in each of the plurality of divided regions; and

an image compression device configured to obtain the surrounding image data and compress the surrounding image data in each of the plurality of divided regions into codes based on the data compression rate set for each of the divided regions.

An image compressing method according to the present invention comparable to the image compressing apparatus comprises:

a first step for detecting at predetermined intervals a position of a currently travelling vehicle to which the method is applied;

a second step for checking the position of the currently travelling vehicle detected in the first step with a map information so that a road shape at each travelling spot of the currently travelling vehicle is recognized;

a third step for determining whether a first road shape recognized then is equal to a second road shape previously recognized;

a fourth step for dividing a display screen of surrounding image data of the currently travelling vehicle into a plurality of divided regions depending on the first road shape when the third step determines that the first road shape is not equal to the second road shape, the fourth step further setting a data compression rate suitable for the first road shape in each of a plurality of first divided regions in the plurality of divided regions set on the display screen;

a fifth step for determining whether a relative dimension on the display screen of a second divided region previously set on the display screen depending on the second road shape should be adjusted when the third step determines that the first road shape is equal to the second road shape;

a sixth step for recognizing a travelling progress of the currently travelling vehicle then based on the first road shape and adjusting the relative dimension on the display screen of the second divided region based on the travelling progress when the fifth step determines that the relative dimension should be adjusted; and

a seventh step for compressing the surrounding image data into codes based on the data compression rate set for the plurality of first divided regions or the second divided region in each of the plurality of first divided regions or the second divided region.

The position of the currently travelling vehicle detected by the position detection device is inputted to the road shape recognition device. The road shape recognition device recognizes the road shape based on the position of the currently travelling vehicle and outputs the recognized road shape to the image division device. The image division device divides the display screen of the surrounding image data into a plurality of divided regions based on the road shape and differently allocates the data compression rate to each of the divided regions. The image compression device compresses the surrounding image data in each of the divided regions into codes based on the data compression rate allocated thereto. According to the image compressing apparatus thus technically characterized, the data compression rate which is relatively low is allocated to any of the divided regions where an accident is likely to occur so that the surrounding image data is compressed into codes with a relatively high image quality, but the data compression rate which is relatively high is allocated to any of the divided regions where an accident is unlikely to occur so that the surrounding image data is compressed into codes with a relatively low image quality. The image quality is improved to show an image with a higher definition in any of the divided regions where there is a high likelihood of accident, while a coding mount is lowered in any of the divided regions where the occurrence of an accident is less likely. As a result, long-hour recording is available while ensuring a high image quality in any significant images, thereby dissolving the relationship of trade-off between the image quality and recording time.

2) The image compressing apparatus according to the present invention is preferably technically characterized in that the road shape recognition device stores therein in advance the map information including the road shape at each travelling spot, and the road shape recognition device checks the position of the currently travelling vehicle with the map information to thereby recognize the road shape at each travelling spot of the currently travelling vehicle.

3) The image compressing apparatus according to the present invention is preferably technically characterized in that the position detection device further detects a direction of the currently travelling vehicle, the road shape recognition device recognizes a travelling progress of the currently travelling vehicle at each travelling spot based on a change of the road shape at each travelling spot, and the image division device adjusts the divided regions and the data compression rate depending on the road shape and the travelling progress.

4) The image compressing apparatus recited in 3) is preferably further technically characterized in that the position detection device further detects a direction of the currently travelling vehicle, and the road shape recognition device recognizes the travelling progress of the currently travelling vehicle at each travelling spot based on the road shape and the direction of the currently travelling vehicle.

The image compressing apparatus recited in 3) is preferably further technically characterized in that the image division device adjusts relative dimensions of the plurality of divided regions on the display screen of the surrounding image data depending on the travelling progress.

A road where the vehicle is travelling may variously change or hardly change its shape with time. Thus, variability of the road shape is different from one road to another. Taking a straight road, for instance, there is hardly any change in its shape with time. A T-junction road, on the other hand, undergoes a large change as an intersection is approaching with time. Therefore, when the dimension of each divided region is differently set based on the variability of the road shape, the divided regions of the surrounding image data can be more finely set. As a result, the image quality and recording time can be both achieved in a more flexible manner.

6) The image compressing apparatus according to the present invention preferably further comprises a vehicle speed detection device configured to detect a travelling speed of the currently travelling vehicle, wherein the image division device continuously changes the relative dimensions of the plurality of divided regions on the display screen and changes an amount of dimensional change per unit time in each of the divided regions depending on the travelling speed.

The image compressing method according to the present invention preferably further comprises an eighth step for detecting a travelling speed of the currently travelling vehicle, wherein the sixth step continuously changes the relative dimensions of the plurality of divided regions on the display screen and changes an amount of dimensional change per unit time in each of the divided regions depending on the travelling speed.

The road shape changes more rapidly as the travelling speed of the vehicle is higher, whereas the road shape changes less frequently as the travelling speed of the vehicle is lower. Therefore, the amount of dimensional change (amount of adjustment) in each of the divided regions is increased as the vehicle is travelling faster, whereas the amount of dimensional change in each of the divided regions is reduced as the vehicle is travelling more slowly. As a result, the divided regions can be more finely set.

7) An image compressing apparatus according to the present invention comprises:

an image compression device configured to obtain surrounding image data of a currently travelling vehicle equipped with the apparatus and compress the obtained surrounding image data into codes;

a speed detection device configured to detect a travelling speed of the vehicle; and

a compression control device configured to perform one or both of a process to set a data compression rate of the surrounding image data depending on the travelling speed and a process to set a frame rate of the surrounding image data depending on the travelling speed, wherein

the image compression device compresses the surrounding image data into codes based on any of the data compression rate, the frame rate, and the data compression rate and the frame rate both respectively set by the compression control device.

An image compressing method according to the present invention comparable to the image compressing apparatus comprises:

a first step for detecting a travelling speed of a currently travelling vehicle to which the method is applied;

a second step for setting one of a data compression rate and a frame rate of surrounding image data of the currently travelling vehicle depending on the travelling speed detected in the first step; and

a third step for obtaining the surrounding image data and compressing the obtained surrounding image data into codes based on one of the data compression rate and the frame rate set in the second step.

The travelling speed of the vehicle detected by the speed detection device is inputted to the compression control device. The compression control device decides the data compression rate and/or the frame rate suitable for the travelling speed and transmits the decided data compression rate and/or frame rate to the image compression device. The image compression device compresses the surrounding image data into codes based on the decided data compression rate and/or frame rate suitable for the received travelling speed. A rate of accident occurrence is associated with the travelling speed of the vehicle as well as the road shape. The occurrence of an accident is less likely when the vehicle is running real slow but is more likely when the vehicle is running very fast. Therefore, the data compression rate is decreased or the frame rate is increased when the vehicle is running fast so that a high image quality is achieved, but the data compression rate is increased or the frame rate is decreased when the vehicle is running slow. As a result, a compression coding amount of the surrounding image data is lessened so that the recording time is increased.

8) An image compressing apparatus according to the present invention comprises:

an image compression device configured to obtain surrounding image data of a currently travelling vehicle equipped with the apparatus and compress the obtained surrounding image data into codes;

a degree of acceleration detection device configured to detect a degree of acceleration of the vehicle; and

a compression control device configured to perform one or both of a process to set a data compression rate of the surrounding depending on the degree of acceleration and a process to set a frame rate of the surrounding depending on the degree of acceleration, wherein

the image compression device compresses the surrounding image data into codes based on any of the data compression rate, the frame rate, and the data compression rate and the frame rate both respectively set by the compression control device.

An image compressing method according to the present invention comparable to the image compressing apparatus comprises:

a first step for detecting a degree of acceleration of a currently travelling vehicle to which the method is applied;

a second step for setting one of a data compression rate and a frame rate of surrounding image data of the currently travelling vehicle depending on the degree of acceleration detected in the first step; and

a third step for obtaining the surrounding image data and compressing the obtained surrounding image data into codes based on one of the data compression rate and the frame rate set in the second step.

The degree of acceleration of the vehicle detected by the degree of acceleration detection device is inputted to the compression control device. The compression control device decides the data compression rate and/or the frame rate suitable for the degree of acceleration and transmits the decided data compression rate and/or frame rate to the image compression device. The image compression device compresses the surrounding image data into codes based on the received data compression rate and/or frame rate suitable for the degree of acceleration. A rate of accident occurrence is associated with the travelling speed of the vehicle as well as the road shape. A likelihood of accident increases when the vehicle suddenly starts or suddenly stops, or is suddenly accelerated or making a sharp curve turn than when the vehicle is running at a constant speed. Therefore, the image data is preferably recorded with a higher quality as the vehicle is more accelerated. Based on the understanding, the data compression rate is decreased or the frame rate is increased as the vehicle is more accelerated to improve the image quality, while the data compression rate is increased or the frame rate is decreased as the vehicle is less accelerated to reduce the compression coding amount and thereby succeed in long-hour recording.

9) An image compressing apparatus according to the present invention comprises:

an image compression device configured to obtain surrounding image data of a currently travelling vehicle equipped with the apparatus and compress the obtained surrounding image data into codes;

a position detection device configured to detect a position of the currently travelling vehicle;

a position comparison device configured to preregister an arbitrary position and determine whether the position of the currently travelling vehicle detected by the position detection device is equal to the preregistered arbitrary position; and

a compression control device configured to perform one or both of an adjustment process to decrease a data compression rate of the surrounding image data and an adjustment process to increase a frame rate of the surrounding image data when the position comparison device determines that the position of the currently travelling vehicle is equal to the preregistered arbitrary position, wherein

the image compression device compresses the surrounding image data into codes based on any of the data compression rate, the frame rate, and the data compression rate and the frame rate both respectively adjusted by the compression control device.

An image compressing method according to the present invention comparable to the image compressing apparatus comprises:

a first step for detecting a position of a currently travelling vehicle to which the method is applied;

a second step for preregistering an arbitrary position and determining whether the position of the currently travelling vehicle detected in the first step is equal to the preregistered arbitrary position;

a third step for performing one or both of an adjustment process to decrease a data compression rate of surrounding image data of the currently travelling vehicle and an adjustment process to increase a frame rate of the surrounding image data when the second step determines that the position of the currently travelling vehicle is equal to the preregistered arbitrary position; and

a fourth step for obtaining the surrounding image data and compressing the surrounding image data into codes based on any of the data compression rate, the frame rate, and the data compression rate and the frame rate both respectively adjusted in the third step.

A high accident spot has a higher probability of experiencing an accident. Therefore, the image data is preferably recorded with a high image quality while the travelling vehicle is currently at any high accident spot. The positional information of the vehicle detected by the position detection device is inputted to the position comparison device. The position comparison device compares the position of the vehicle to the preregistered arbitrary position and transmits a result of the comparison to the compression control device. As far as the comparison result says that the two positions are equal to each other, the compression control device decreases the data compression rate or increases the frame rate, and then transmits the resulting data compression rate and/or frame rate to the image compression device. The image compression device compresses the surrounding image data into codes based on the received data compression rate and/or frame rate. For example, the data compression rate is decreased or the frame rate is increased while the vehicle is passing through the preregistered arbitrary position (for example, high accident spot) to improve the image quality. While the vehicle is passing through any other positions or spots, the data compression rate is increased or the frame rate is decreased to reduce the compression coding amount of the surrounding image data and thereby succeed in long-hour recording.

10) An image compressing apparatus according to the present invention comprises:

an image compression device configured to obtain surrounding image data of a currently travelling vehicle equipped with the apparatus and compress the obtained surrounding image data into codes;

a position detection device configured to detect a position of the currently travelling vehicle;

a route comparison device configured to preregister an arbitrary travelling route and determine whether the position of the currently travelling vehicle detected by the position detection device is deviating from the preregistered arbitrary travelling route; and

a compression control device configured to perform one or both of an adjustment process to decrease a data compression rate of the surrounding image data and an adjustment process to increase a frame rate of the surrounding image data when the route comparison device determines that the position of the currently travelling vehicle is deviating from the preregistered arbitrary travelling route, wherein

the image compression device compresses the surrounding image data into codes based on any of the data compression rate, the frame rate, and the data compression rate and the frame rate both respectively adjusted by the compression control device.

An image compressing method according to the present invention comparable to the image compressing apparatus comprises:

a first step for detecting a position of a currently travelling vehicle to which the method is applied;

a second step for preregistering an arbitrary travelling route and determining whether the position of the currently travelling vehicle detected in the first step is deviating from the preregistered arbitrary travelling route;

a third step for performing one or both of an adjustment process to decrease a data compression rate of surrounding image data of the currently travelling vehicle and an adjustment process to increase a frame rate of the surrounding image data when the second step determines that the position of the currently travelling vehicle is deviating from the preregistered arbitrary travelling route; and

a fourth step for compressing the surrounding image data into codes based on any of the data compression rate, the frame rate, and the data compression rate and the frame rate both respectively adjusted in the third step.

Focusing on the travelling route, in particular, among the driving conditions of the vehicle, an accident is more likely occur when the vehicle is travelling on an inexperienced road for the first time than when travelling on any roads where the vehicle may travel on a daily basis. Therefore, the image data is preferably recorded with a high image quality while the vehicle is travelling on any inexperienced road. The positional information of the vehicle detected by the position detection device is inputted to the route comparison device. The route comparison device compares the position of the vehicle to the preregistered travelling route and transmits a result of the comparison to the compression control device. In the case where that the vehicle position is irrelevant to the preregistered travelling route according to the comparison result, the compression control device decreases the data compression rate or increases the frame rate, and then transmits the resulting data compression rate and/or frame rate to the image compression device. The image compression device compresses the surrounding image data into codes based on the received data compression rate and/or frame rate. For example, the data compression rate is decreased or the frame rate is increased while the vehicle is travelling on any unfamiliar road to improve the image quality, but the data compression rate is increased or the frame rate is decreased otherwise to reduce the compression coding amount of the surrounding image data and thereby succeed in long-hour recording.

11) A vehicle-mounted image recording apparatus according to the present invention comprises:

an imaging device configured to obtain surrounding image data of a currently travelling vehicle equipped with the apparatus;

an image processing device configured to image-process the surrounding image data outputted from the imaging device;

an image compression device configured to compress the surrounding image data image-processed by the image processing device; and

a recording device configured to record therein the surrounding image data compressed by the image compression device.

The vehicle-mounted image recording apparatus thus technically characterized can extensively record the circumstances of an accident if occurred.

### Effect of the Invention

According to the present invention, the display screen of the surrounding image data is divided into a plurality of divided regions based on the shape of the road where the vehicle is currently running, and the surrounding image data in any of the divided regions where there is a high likelihood of accident is compressed with a lower data compression rate to place an emphasis on improvement of an image quality, and the surrounding image data in any other regions is compressed with a higher data compression rate so that the compression coding amount is reduced. This technical characteristic enables the image data to be recorded over a long period of time while ensuring a high image quality in any images of significance, thereby dissolving the relationship of trade-off between the image quality and recording time.

Another technical advantage to be emphasized is to record images with an image quality flexibly set for different circumstances by controlling the image data compression rate and/or frame rate based on the positional information, speed information, and acceleration information of the vehicle.

### BRIEF DESCRIPTION OF THE DRAWINGS

FIG. 1 is a block diagram illustrating a structural characteristic of a vehicle-mounted image recording apparatus according to an exemplary embodiment 1 of the present invention.

FIG. 2 is a flow chart illustrating a flow of processing steps carried out by an image compressing apparatus according to the exemplary embodiment 1.

FIG. 3 is a table of division methods according to the exemplary embodiment 1.

FIG. 4 is a drawing of an image captured when travelling on a straight road according to the exemplary embodiment 1.

FIG. 5 illustrates an example of image division in the image captured when travelling on the straight road according to the exemplary embodiment 1.

FIG. 6 illustrates an example of image division in an image captured when travelling on a T-junction road according to the exemplary embodiment 1.

FIG. 7 illustrates an example of image division captured when travelling on the T-junction road after a unit time passed according to the exemplary embodiment 1.

FIG. 8 illustrates an example of image division in an image captured when making a curve turn to left according to the exemplary embodiment 1.

FIG. 9 illustrates an example of image division in an image captured making a curve turn to right according to the exemplary embodiment 1.

FIG. 10 illustrates an amount of dimensional change in a divided region per unit time according to the exemplary embodiment 1.

FIG. 11A is a drawing 1) illustrating an example of image division when a vehicle is about to turn left according to the exemplary embodiment 1.

FIG. 11B is a drawing 2) illustrating the example of image division when the vehicle is about to turn left according to the exemplary embodiment 1.

FIG. 12A is a drawing 1) illustrating an example of image division when the vehicle is currently turning left according to the exemplary embodiment 1.

FIG. 12B is a drawing 2) illustrating the example of image division when the vehicle is currently turning left according to the exemplary embodiment 1.

FIG. 13A is a drawing 1) illustrating an example of image division when the vehicle already turned left according to the exemplary embodiment 1.

FIG. 13B is a drawing 2) illustrating the example of image division when the vehicle already turned left according to the exemplary embodiment 1.

FIG. 14A is a drawing 1) illustrating an example of image division when a vehicle is about to turn right according to the exemplary embodiment 1.

FIG. 14B is a drawing 2) illustrating the example of image division when the vehicle is about to turn right according to the exemplary embodiment 1.

FIG. 15A is a drawing 1) illustrating an example of image division when the vehicle is currently turning right according to the exemplary embodiment 1.

FIG. 15B is a drawing 2) illustrating the example of image division when the vehicle is currently turning right according to the exemplary embodiment 1.

FIG. 16A is a drawing 1) illustrating an example of image division when the vehicle already turned right according to the exemplary embodiment 1.

FIG. 16B is a drawing 2) illustrating the example of image division when the vehicle already turned right according to the exemplary embodiment 1.

FIG. 17 is a block diagram illustrating a structural characteristic of a vehicle-mounted image recording apparatus according to an exemplary embodiment 2 of the present invention.

FIG. 18 is a table of amounts of dimensional change decided based on a travelling speed according to the exemplary embodiment 2.

FIG. 19 is a flow chart illustrating a flow of processing steps carried out by an image compressing apparatus according to the exemplary embodiment 2.

FIG. 20 is a block diagram illustrating a structural characteristic of a vehicle-mounted image recording apparatus according to an exemplary embodiment 3 of the present invention.

FIG. 21 is a flow chart illustrating a flow of processing steps carried out by an image compressing apparatus according to the exemplary embodiment 3.

FIG. 22 is a table of frame rates decided based on a travelling speed according to the exemplary embodiment 3.

FIG. 23 is a table of data compression rates decided based on the travelling speed according to the exemplary embodiment 3.

FIG. 24 is a block diagram illustrating a structural characteristic of a vehicle-mounted image recording apparatus according to an exemplary embodiment 4 of the present invention.

FIG. 25 is a flow chart illustrating a flow of processing steps carried out by an image compressing apparatus according to the exemplary embodiment 4.

FIG. 26 is a table of frame rates decided based on a degree of acceleration according to the exemplary embodiment 4.

FIG. 27 is a table of data compression rates decided based on the degree of acceleration according to the exemplary embodiment 4.

FIG. 28 is a block diagram illustrating a structural characteristic of a vehicle-mounted image recording apparatus according to an exemplary embodiment 5 of the present invention.

FIG. 29 is a flow chart illustrating a flow of processing steps carried out by an image compressing apparatus according to the exemplary embodiment 5.

FIG. 30 is a block diagram illustrating a structural characteristic of a vehicle-mounted image recording apparatus according to an exemplary embodiment 6 of the present invention.

FIG. 31 is a flow chart illustrating a flow of processing steps carried out by an image compressing apparatus according to the exemplary embodiment 6.

FIG. 32 is a block diagram illustrating a structural characteristic of a vehicle-mounted image recording apparatus according to an exemplary embodiment 7 of the present invention.

FIG. 33 is a flow chart 1) illustrating a flow of processing steps carried out by an image compressing apparatus according to the exemplary embodiment 7.

FIG. 34 is a flow chart 2) illustrating the flow of processing steps carried out by the image compressing apparatus according to the exemplary embodiment 7.

FIG. 35 is a flow chart 3) illustrating the flow of processing steps carried out by the image compressing apparatus according to the exemplary embodiment 7.

FIG. 36 is a table of frame rate correction values and data compression rate correction values decided based on a travelling speed according to the exemplary embodiment 7.

FIG. 37 is a table of frame rate correction values and data compression rate correction values decided based on a degree of acceleration according to the exemplary embodiment 7.

### EXEMPLARY EMBODIMENTS FOR CARRYING OUT THE INVENTION

Hereinafter, exemplary embodiments of an image compressing apparatus and a vehicle-mounted image recording apparatus according to the present invention are described in detail referring to the drawings. The exemplary embodiments hereinafter described are just examples and may be variously modified including modified embodiments described later.

### Exemplary Embodiment 1

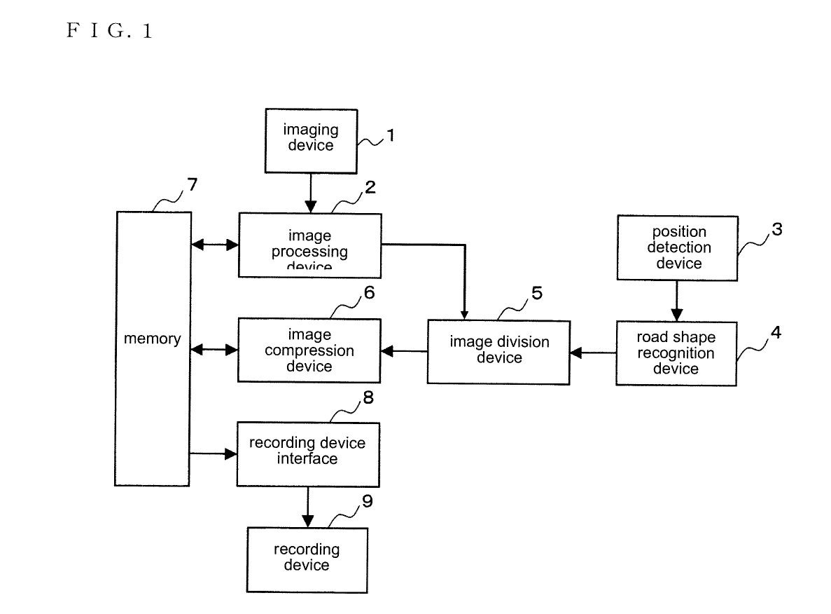

FIG. 1 is a block diagram illustrating a structural characteristic of a vehicle-mounted image recording apparatus according to an exemplary embodiment 1 of the present invention.

The vehicle-mounted image recording apparatus has an imaging device 1, an image processing device 2, a position detection device 3, a road shape recognition device 4, an image division device 5, an image compression device 6, a memory 7, a recording device interface 8, and a recording device 9.

The imaging device 1 captures surrounding images of a currently travelling vehicle loaded with the apparatus. The image processing device 2 image-processes data of the surrounding images outputted from the imaging device 1. The position detection device 3 detects a position of the currently travelling vehicle. The road shape recognition device 4 stores therein map information including road shapes at different locations in advance, and checks the vehicle position detected by the position detection device 3 with the stored map information to thereby recognize the road shape at the position detected by the position detection device 3 where the vehicle is currently located. The image division device 5 divides a display screen of the surrounding image data into a plurality of divided regions depending on the road shape recognized by the road shape recognition device 4, and differently allocates a suitable data compression rate to each of the divided regions. The position detection device 3 detects a direction of the currently travelling vehicle. The road shape recognition device 4 recognizes a travelling progress of the vehicle at each travelling spot based on the road shape and the vehicle direction. The image division device 5 adjusts the divided regions and the data compression rate in a manner suitable for the road shape and the travelling progress. The direction of the currently travelling vehicle is detected by, for example, a gyroscope. Though detecting the vehicle direction is very useful to more accurately recognize the travelling progress of the vehicle, changes of the road shape at travelling spots are also very useful information that can be used in place of the detection of the vehicle direction to recognize the travelling progress of the vehicle at each travelling spot. The image compression device 6 compresses the surrounding image data processed by the image processing device 2 into codes by each of the divided regions based on the data compression rate allocated thereto by the image division device 5. The memory 7 temporarily stores therein the surrounding image data processed by the image processing device 2 and the surrounding image data compressed into codes by the image compression device 6. The recording device interface 8 records the compressed data stored in the memory 7 in the recording device 9. Then, the compressed data is recorded in the recording device 9.

The image processing device 2, image division device 5, image compression device 6, and recording device interface 8 may be configured as a single chip LSI.

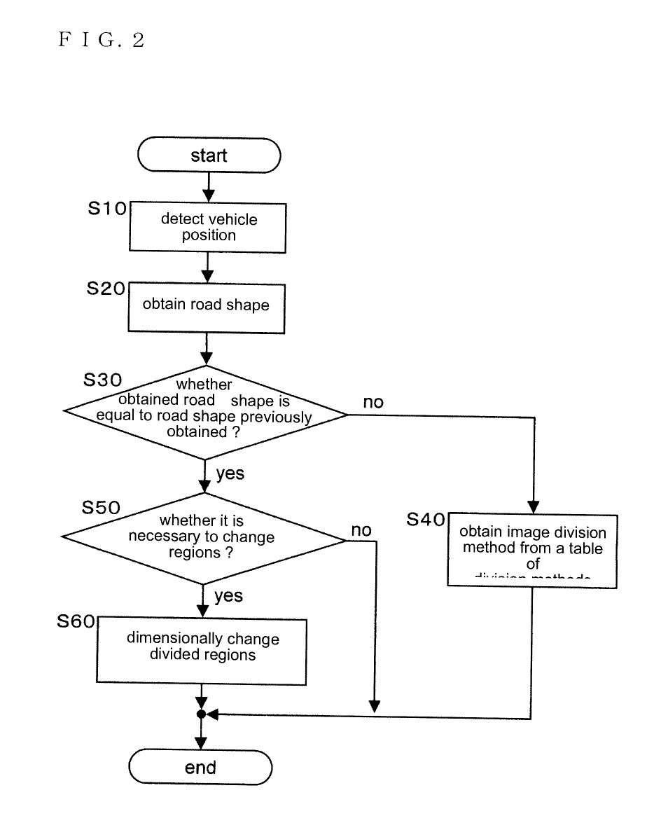

FIG. 2 is a flow chart illustrating a flow of processing steps carried out by an image compressing apparatus according to the exemplary embodiment 1. In Step S10, the road shape recognition device 4 obtains information relating to the vehicle position (hereinafter, called vehicle positional information) from the position detection device 3. In Step S20, the road shape recognition device 4 checks the obtained vehicle positional information with the map information stored therein in advance (more specifically, information of the road shapes at travelling spots) to thereby recognize the shape of the road where the vehicle is currently traveling. The road shape recognition device 4 thus recognizes the road shape at predetermined time intervals (for example, by every 100 seconds). The time interval may be changed depending on a travelling speed of the vehicle. Though the position detection device 3 and the road shape recognition device 4 are basically devices independently provided in the apparatus, GPS (global positioning system) of an existing car navigation system and the map information (road shapes at travelling spots) may be used in place of these devices.

In Step S30, the road shape recognition device 4 determines whether the road shape obtained then (first road condition) is equal to the road shape obtained previously (second road condition), and the processing flow proceeds to different processing steps depending on a result obtained in Step S30. When the road shape recognition device 4 determined that the road shapes are different, the processing flow proceeds to Step S40. When the road shape recognition device 4 determined that the road shapes are consistent with each other, the processing flow proceeds to Step S50.

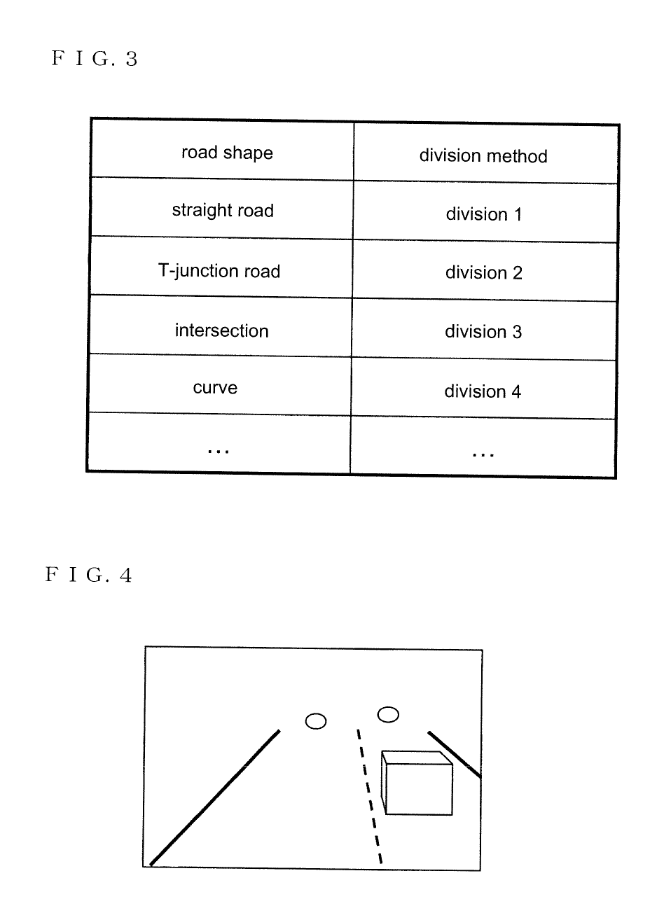

In Step S40, the image division device 5 obtains an image division method from a table of division methods (not illustrated in the drawings) suitable for the road shape obtained then. The table of division methods recites methods of dividing an image displayed on a display screen which are suitably set for different road shapes. For example, such division methods as illustrated in FIG. 3 are available for various road shapes such as straight road, T-junction road, intersection, and curved road. FIG. 4 is a pre-division image (display screen), which is captured by the imaging device 1. First, the display screen is divided into a left region 51A mostly including a traffic lane where the vehicle is travelling, and a right region 52A mostly including an opposite traffic lane where an oncoming vehicle is travelling.

When the straight road is divided, ⅔ on the left side of the display screen is the left region 51A, and ⅓ on the right side of the display screen is the right region 52A. Then, the right region 52A of the straight road is further divided into a right-side lower region 52Aa near the vehicle and dimensionally equal to about the lower half of the right region 52A, and a right-side upper region 52Ab farther from the vehicle than the right-side lower region 52Aa and dimensionally equal to about the upper half of the right region 52A. Of these three divided regions, target subjects in the right-side lower region 52Aa and the right-side upper region 5Ab have considerable inter-frame motion. Therefore, the surrounding image data in these regions 52Aa and 52Ab have a poor image quality unless the data compression rate thereof is lowered. There is a possibility that the right-side lower region 52Aa shortly undergoes an accident between the vehicle and the oncoming vehicle such as head-on collision, making it necessary to record the surrounding image data in the region 52Aa with a high image quality. On the other hand, the right-side upper region 52Ab, though similarly including a possibility of accident between the vehicle and the oncoming vehicle such as head-on collision, is unlikely to experience any accident sometime soon. Therefore, the surrounding image data of the region 52Ab may have a lower image quality than that of the region 52Aa near the opposite traffic lane. In the left region 51A, the vehicle possibly collides into another vehicle travelling ahead of the vehicle on the same traffic lane (hereinafter, called leading vehicle), however, a target subject (leading vehicle) in this region has a small amount of inter-frame motion because the two vehicles are travelling in the same direction. Therefore, the image quality is not overly degraded when the data compression rate in this region 51A is increased. Based on the description given so far, the data compression rate of the surrounding image data is set to different levels in these three regions as illustrated in FIG. 5; high in the left region 51A, intermediate in the right-side upper region 52Ab, and low in the right-side lower region 52Aa.

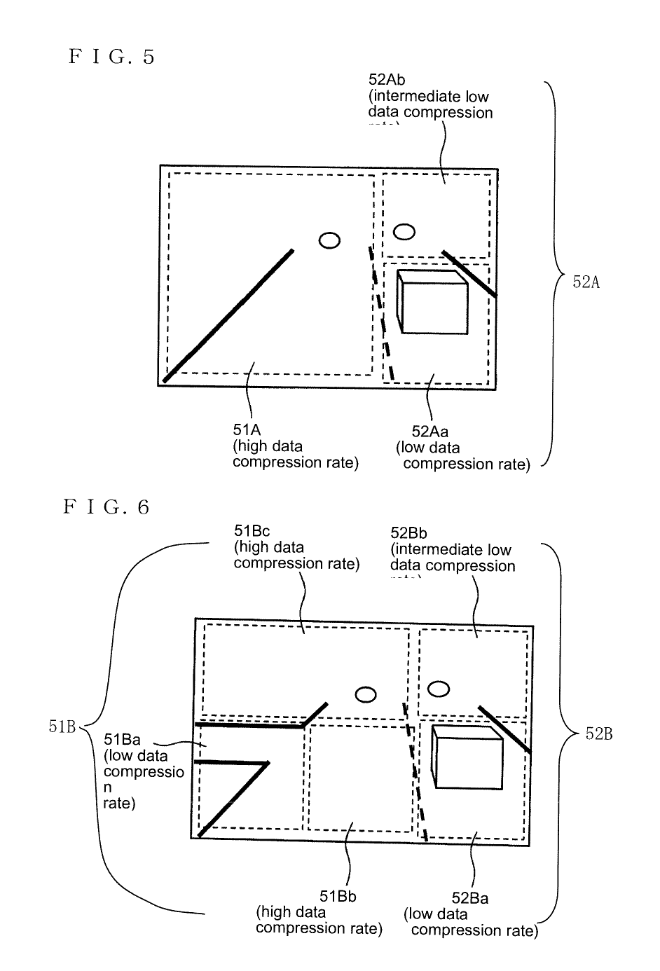

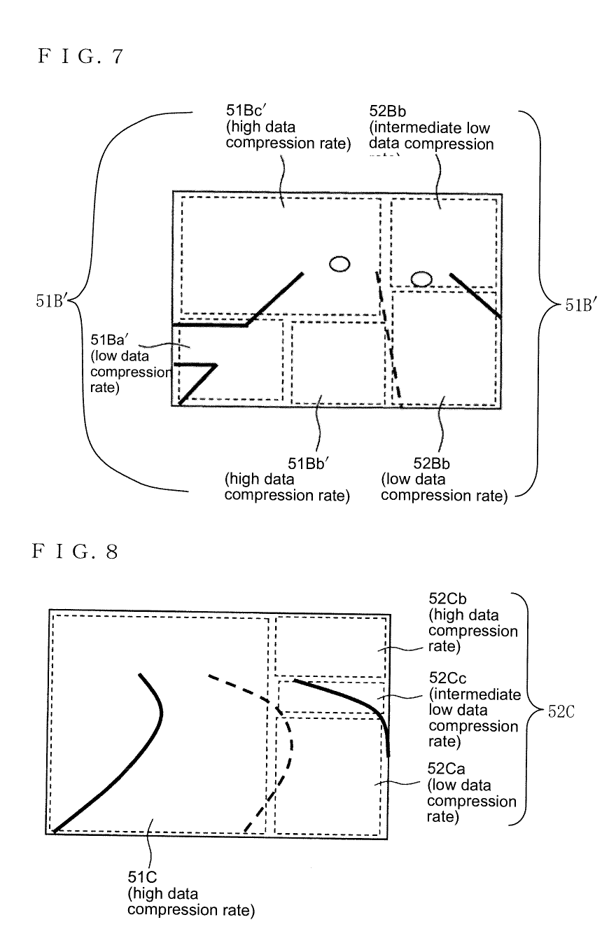

The surrounding image data on a T-junction road or at an intersection is divided as described below. Though a T-junction road is described below, any intersection will be handled similarly. Any T-junction roads include more high accident spots unlike the straight road. Therefore, the display screen is divided as illustrated in FIG. 6. Similarly to the straight road, the display screen is divided into a left region 51B dimensionally equal to ⅔ on the left side of the display screen, and a right region 52B dimensionally equal to ⅓ on the right side of the display screen. Then, the left region 51B is further divided into a left lower-left region 51Ba, a left lower-right region 51Bb, and a left upper region 51Bc, and the most suitable data compression rate is allocated to each of these regions 51Ba, 51Bb, and 51Bc, more specifically set as described below. The left lower region 51Ba includes a T-junction intersection where the traffic lane intersects with a road. At the T-junction intersection, such an accident as collision more possibly occurs between the vehicle and another vehicle running transversely across the traffic lane of the vehicle. Therefore, the data compression rate is set low in the left lower-left region 51Ba (high image quality). The data compression rate is set high in the left lower-right region 51Bb and the left upper region 51Bc similarly to the left region 51A of the straight road. Similarly to the straight road, the data compression rate is set low and intermediate in the right lower region 52Ba and the left upper region 52Bb.

When making a curve turn to left, the display screen is divided as described below. The road curving to left includes more high accident spots than the straight road. Therefore, the display screen is divided similarly to the straight road as illustrated in FIG. 8. More specifically, the display screen is divided into a left region 51C dimensionally equal to ⅔ on the left side of the display screen, and a right region 52C dimensionally equal to ⅓ on the right side of the display screen. Then, the right region 52C is further divided into a right lower region (mostly including the opposite traffic lane near the vehicle) 52Ca dimensionally equal to about the lower half of the right region 52C, a right upper region (mostly including a zone other than the traffic lane) 52Cb dimensionally equal to about upper ⅔ of the upper half of the right region 52C, and a right center region (mostly including the opposite traffic lane distant from the vehicle) 52Cc dimensionally equal to about lower ⅓ of the upper half of the right region 52C. Of these four divided regions, the right lower region 52Ca and the right center region 52Cc mostly include the opposite traffic lane, and images of these regions 52Ca and 52Cc have a large amount of inter-frame motion. Therefore, the images have a poor image quality unless the data compression rate is set low for the surrounding image data in the regions 52Ca, 52Cb, and 52Cc. Of these regions 52Ca and 52Cc thus characterized, the right lower region 52Ca mostly includes the opposite traffic lane near the vehicle, in which an accident, such as collision between the vehicle and another vehicle, more possibly occurs. Therefore, the data compression rate for recording the surrounding image data in the region 52Ca is decreased to a lowest level (high image quality). On the other hand, the right center region 52Cc mostly includes the opposite traffic lane distant from the vehicle, in which any accident, such as collision, probably does not occur shortly. The right center region 52Cc, however, quite possibly includes collision-related images immediately before the impact if the vehicle and another vehicle collide with each other in the region 52Ca. Therefore, the image quality of the surrounding image data in the region 52Cc, though set lower than the surrounding image data in the region 52Ca, should meet a relatively high quality level. More specifically, the surrounding image data in the region 52Cc is compressed with the intermediate date compression rate (intermediate image quality). Because the right upper region 52Cb mostly includes a zone other than the traffic lane, the surrounding image data in this region should have a low image quality (high data compression rate).

Based on the description given so far, when making a curve turn to left, the surrounding image data of the left region 51C on the road curving left is compressed with the high data compression rate, the surrounding image data of the right lower region 52Ca is compressed with the low data compression rate, the surrounding image data of the right upper region 52Cb is compressed with the high data compression rate, and the surrounding image data of the right center region 52Cc is compressed with the intermediate data compression rate as illustrated in FIG. 8.

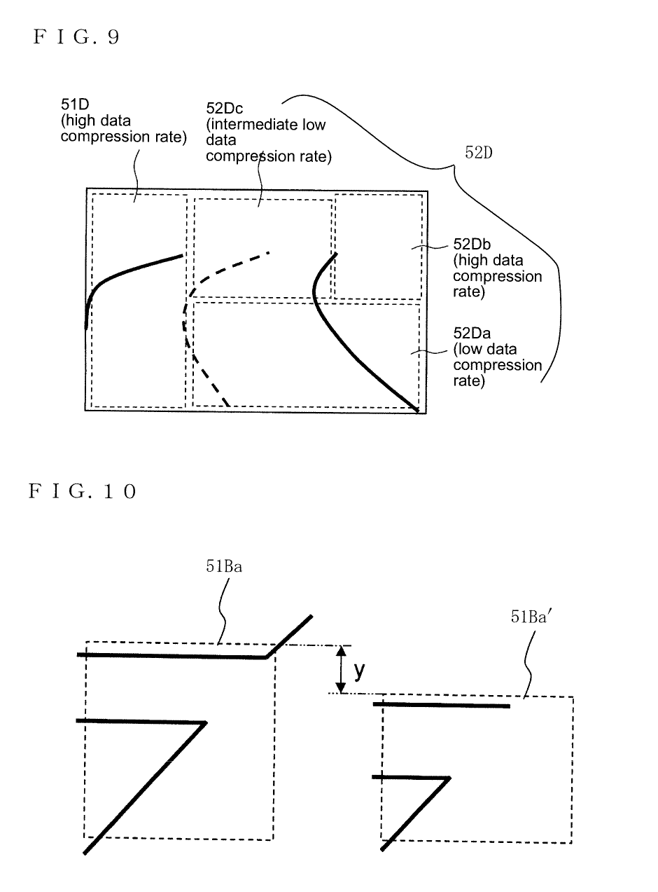

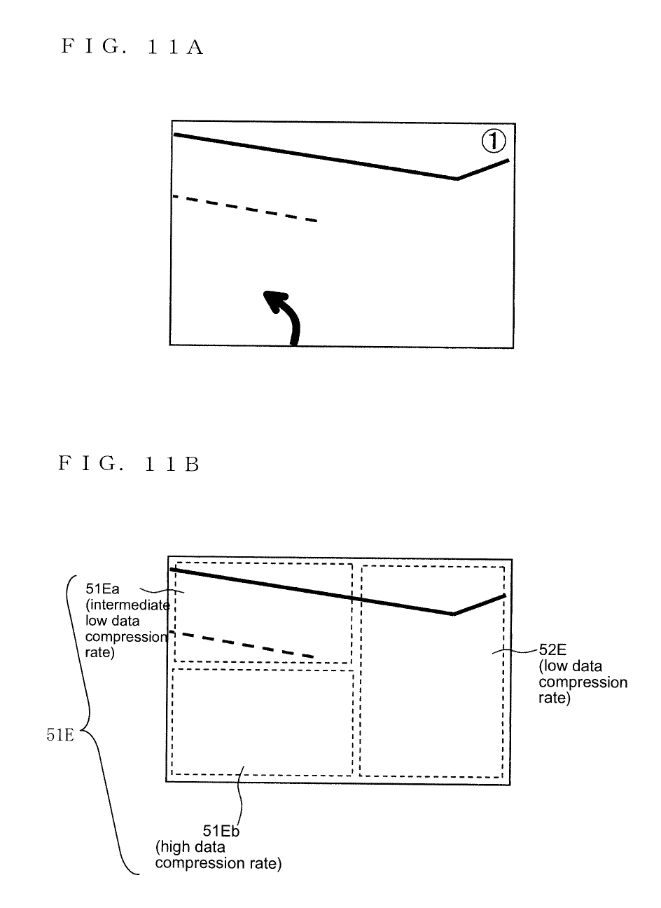

When making a curve turn to right, the display screen is divided as described below. The road curving to left includes more high accident spots than the straight road. Therefore, the display screen is divided as illustrated in FIG. 9. More specifically, the display screen is divided into a left region 51D dimensionally equal to ⅓ on the left side of the display screen, and a right region 52D dimensionally equal to ⅔ on the right side of the display screen. Then, the right region 52D is further divided into a right lower region 52Da dimensionally equal to about the lower half of the right region 52D, a right upper-right region 52Db dimensionally equal to about right-side ⅓ of the upper half of the right region 52D, and a right upper-left region 52Dc dimensionally equal to about left-side ⅔ of the upper half of the right region 52D. Of these four divided regions, the right lower region 52Da and the right upper-left region 52Dc mostly include the opposite traffic lane, and images of these regions 52Da and 52Dc have a large amount of inter-frame motion. Therefore, the images have a poor image quality unless the data compression rate for recording the surrounding image data in the regions 52Da and 52Dc is set low. Of these regions 52Da and 52Dc thus characterized, the right lower region 52Da mostly includes the opposite traffic lane near the vehicle, in which an accident, such as collision between the vehicle and another vehicle, more possibly occurs. Therefore, the data compression rate for recording the surrounding image data in the region 52Da should be reduced to a lowest level (high image quality). On the other hand, the right upper-left region 52Dc mostly includes the opposite traffic lane distant from the vehicle, in which any accident, such as collision, probably does not occur shortly. The region 52Dc, however, quite possibly includes collision-related images immediately before the impact if the vehicle and another vehicle collide with each other in the region 52Da. Therefore, the image quality of the surrounding image data in the region 52Dc, though set lower than the surrounding image data in the region 52Da, should meet a relatively high quality level. More specifically, the surrounding image data in the region 52Dc is compressed with the intermediate date compression rate (intermediate image quality). Because the right upper-right region 52Db mostly includes a zone other than the traffic lane, the surrounding image data in this region should have a low image quality (high data compression rate). The division methods described so far are recited in the table of division methods.

The flow chart of FIG. 2 is described again. When the road shape recognition device 4 determines in Step S30 that the road shape obtained then is equal to the road shape obtained previously, the processing flow proceeds to Step S50. The image division device 5 can continuously change the relative dimensions of the respective divided regions on the display screen. The image division device 5 can change the amount of dimensional change in each of the divided regions per unit time. In Step S50, the image division device 5 determines whether the divided regions should be dimensionally changed. The image division device 5, which determined in Step S50 that it is necessary to dimensionally change the divided regions, changes in Step S60 the dimensions of the divided regions. Below are described processing steps in Step S60 for dimensionally changing the divided regions.

The road shapes of any straight roads are substantially constant as the vehicle travels over time. When travelling on a T-junction road, however, a road intersecting with the road (hereinafter, called intersecting road) where the vehicle is travelling (hereinafter, called travelling road) is approaching with time. Therefore, it is necessary to adjust the relative dimensions of the divided regions on the display screen of the surrounding image data depending on the travelling progress recognized by the road shape recognition device 4 in the division method obtained from the table of division methods.

When the vehicle is travelling on the T-junction road, the intersecting road on the display screen positionally changes. Therefore, the relative dimensions of the respective divided regions should be changed relative to one another. FIG. 7 illustrates states of the display screen and regions 51Ba′, 51Bb′, 51Bc′, 52Ba, and 52Bb after a unit time passed. Comparing them to the illustration of FIG. 6, the height dimension of the region 51Ba′ is increased, while the height dimensions of the regions 51Bb′ and 51Bc′ are reduced. The dimensions of the regions 52Ba and 52Bb remain unchanged.

FIG. 10 illustrates a difference y between the height dimensions of the region 51Ba and the region 51Ba′. As the travelling progress of the vehicle advances, the height dimension of the region 51Ba is reduced by a unit of dimensional change y. The unit of dimensional change y is a preset value. When the dimensions of the respective regions are thus changed depending on the constantly changing road shape information, the divided regions of the surrounding image data can be more finely adjusted so that the image quality and recording time can be both achieved in a more flexible manner.

The road shape is not the only factor based on which the image division is changed. It is necessary to change the image division depending on the travelling progress of the vehicle at each travelling spot detected based on a direction where the vehicle is moving ahead (vehicle direction). Examples of the vehicle direction are turning right and turning left. Turning right and turning left are preferably divided into a plurality of stages and respectively recited in different tables.

First, turning left is described. FIGS. 11-13 illustrate image division methods when the travelling progress of the vehicle turning left is divided into three stages.

Turning-Left Stage 1

Recognizing that the current travelling progress of the vehicle as a turning-left stage 1 (starting stage) illustrated in FIG. 11A, the display screen is divided into a left region 51E and a right region 52E, and the left region 51E is further divided into a left upper region 51Ea and a left lower region 51Eb as illustrated in FIG. 11B. The right region 52Eb mostly includes an intersection when the vehicle is turning left. At the intersection when the vehicle is turning left, there is a possibility that the vehicle which turned left collides with another vehicle turning right oncoming from an opposite traffic lane. Therefore, the right region 52E is compressed with the low data compression rate. The left upper region 51Ea mostly includes the opposite traffic lane after the vehicle turned left. The opposite traffic lane after the vehicle turned left includes a potential of collision between the oncoming vehicle and the vehicle which turned left, however, is very distant from the vehicle as compared to the intersection when the vehicle is turning left. Therefore, the left upper region 51Ea is compressed with the intermediate data compression rate. The left lower region 51Eb mostly includes the traffic lane where the vehicle is travelling after turning left. On the traffic lane where the vehicle is travelling after turning left, the vehicle and another vehicle are less likely to collide with each other, and the amount of inter-frame motion is small. Therefore, the left lower region 51Eb is compressed with the high data compression rate.

Turning-Left Stage 2

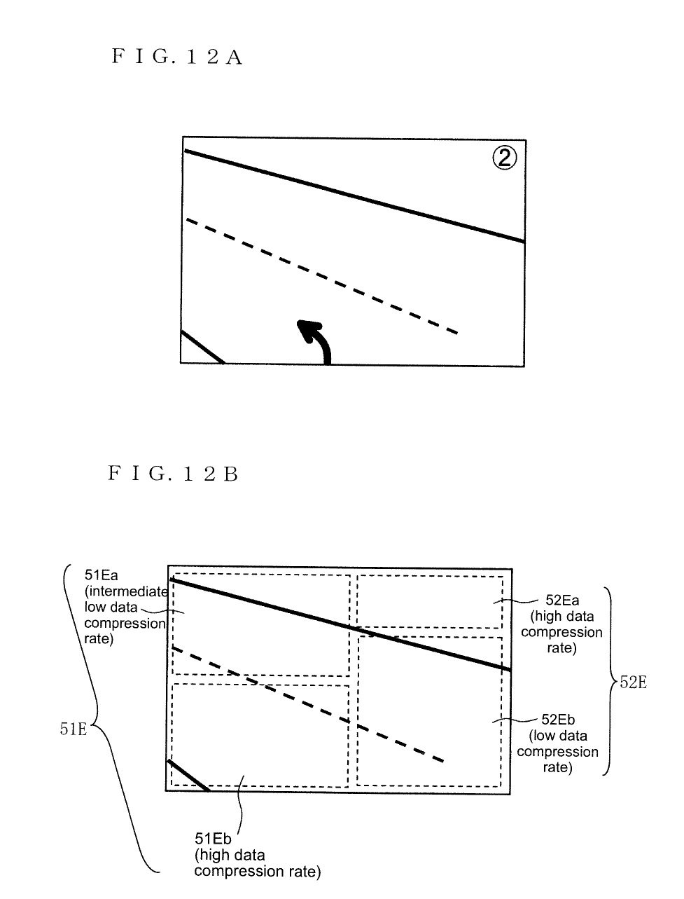

Recognizing that the current travelling progress of the vehicle as a turning-left stage 2 (intermediate stage) illustrated in FIG. 12A, the right region 52E is further divided into a right upper region 52Ea and a right lower region 52Eb as illustrated in FIG. 12B. The right lower region 52Eb mostly includes the opposite traffic lane after the vehicle turned left. On the opposite traffic lane after the vehicle turned left, there is a possibility that the vehicle which turned left collides with another vehicle oncoming from the opposite traffic lane. Therefore, the right lower region 52Eb is compressed with the low data compression rate. The left upper region 51Ea mostly includes the opposite traffic lane after the vehicle turned left, however, is very distant from the vehicle as compared to the right lower region 52Eb. Therefore, the left upper region 51Ea is compressed with the intermediate data compression rate. The left lower region 51Eb including the traffic lane of the vehicle turning left now is compressed with the high data compression rate similarly to the stage 1. The right upper region 52Ea not including any traffic lanes is compressed with the high data compression rate.

Turning-Left Stage 3

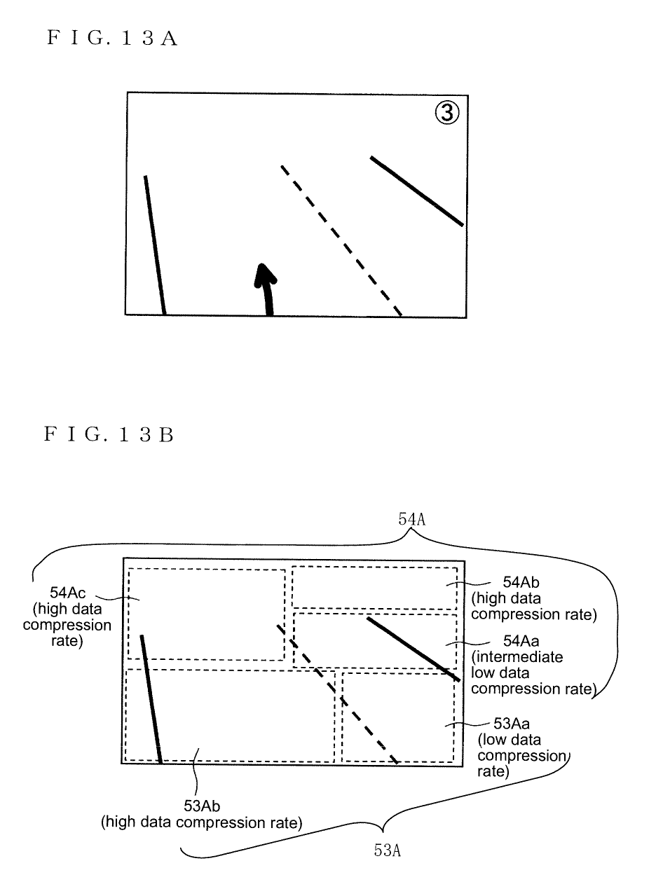

Recognizing that the current travelling progress of the vehicle as a turning-left stage 3 (ending stage) illustrated in FIG. 13A, the display screen is divided into a lower region 53A and an upper region 54A, the lower region 53A is further divided into a lower right region 53Aa and a lower left lower region 53Ab, and the upper region 54A is further divided into an upper lower-right region 54Aa, an upper upper-right region 54Ab, and an upper left region 54Ac as illustrated in FIG. 13B. The lower right region 53Aa mostly includes the opposite traffic lane after the vehicle turned left. The opposite traffic lane after the vehicle turned left is close to the vehicle, suggesting a possibility of collision between the vehicle and another oncoming vehicle. Therefore, the lower right region 53Aa is compressed with the low data compression rate. The upper lower-right region 54Aa, most of which displays the opposite traffic lane after the vehicle turned left, is somewhat distant from the vehicle, suggesting that collision between the vehicle and another oncoming vehicle is possible but less possible than the lower right region 53Aa. Therefore, the upper lower-right region 554Aa is compressed with the intermediate data compression rate. The lower left region 53Ab and the upper left region 54Ac mostly include the traffic lane where the vehicle which turned left 9 is now travelling. It is unlikely that the vehicle and another vehicle collide with each other on the traffic lane where the vehicle which turned left 9 is now travelling. Therefore, the lower left region 52Ab is compressed with the high data compression rate. The upper upper-right region 54Ab hardly including any traffic lanes is compressed with the high data compression rate.

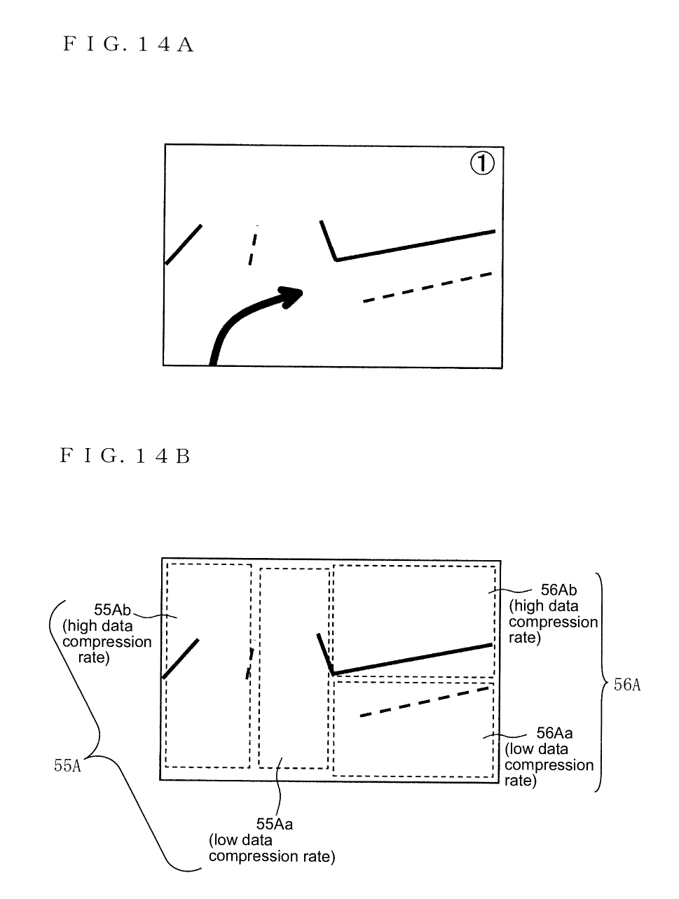

FIGS. 14-16 illustrate image division methods when the travelling progress of the vehicle turning right is divided into three stages.

Turning-Right Stage 1

Recognizing that the current travelling progress of the vehicle as a turning-right stage 1 (starting stage) illustrated in FIG. 14A, the display screen is divided into a left region 55A and a right region 56A, and then, the left region 55A is further divided into a left-side right region 55Aa and a left-side left region 55Ab, and the right region 56A is further divided into a right lower region 56Aa and a right upper region 56Ab as illustrated in FIG. 14B. The right lower region 56Aa mostly includes an opposite traffic lane after the vehicle turned right. On the opposite traffic lane after the vehicle turned right, there is a possibility that the vehicle collides with another vehicle turning left oncoming from the opposite traffic lane. Therefore, the right lower region 56Aa is compressed with the low data compression rate. The left-side right region 55Aa mostly includes the opposite traffic lane before the vehicle turns right. The opposite traffic lane before the vehicle turns right includes a possibility of collision between the oncoming vehicle and the vehicle before turning right. Therefore, the left-side right region 55Aa is compressed with the low data compression rate. The right upper region 56Ab mostly includes the traffic lane where the vehicle which turned right is travelling and a zone other than the traffic lane. It is less likely that the vehicle and another vehicle collide with each other on the traffic lane where the vehicle which turned right is travelling. Therefore, the right upper region 56Ab is compressed with the high data compression rate. The left-side left region 55Ab mostly includes the traffic lane where the vehicle before turning right is travelling. On the traffic lane where the vehicle before turning right is travelling, the vehicle before turning right is less likely to collide with another vehicle. Therefore, the left-side left region 55Ab is compressed with the high data compression rate.

Turning-Right Stage 2

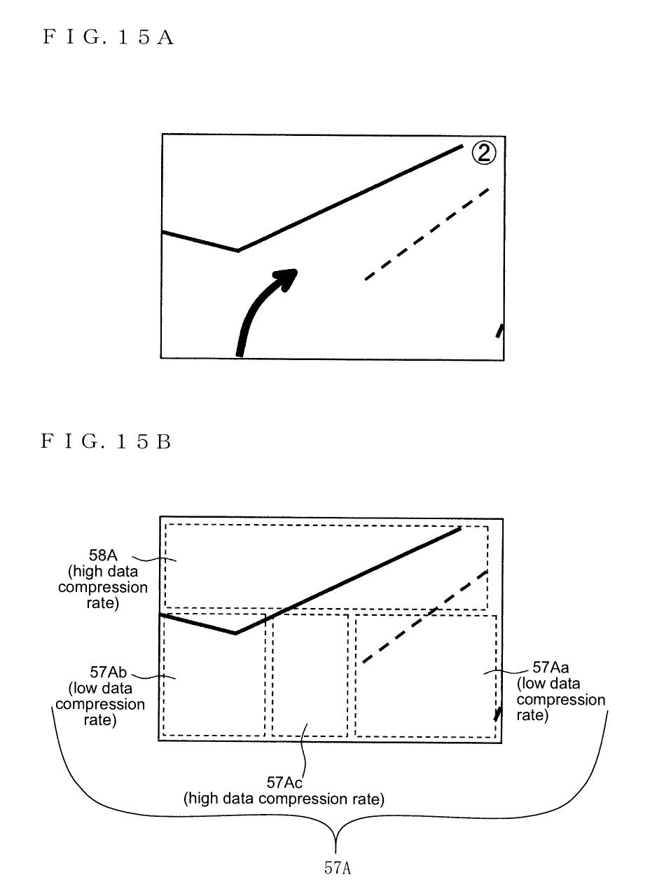

Recognizing that the current travelling progress of the vehicle as a turning-right stage 2 (intermediate stage) illustrated in FIG. 15A, the display screen is divided into a lower region 57A and an upper region 58A, and the lower region 57A is further divided into a lower right region 57Aa, a lower left region 57Ab, and a lower center region 57Ac as illustrated in FIG. 15B. The lower right region 57Aa mostly includes the opposite traffic lane after the vehicle turned right. On the opposite traffic lane after the vehicle turned right, the vehicle possibly collides with another oncoming vehicle. Therefore, the lower right region 57Aa is compressed with the low data compression rate. The lower left region 57Ab mostly includes the opposite traffic lane before the vehicle turns right. On the opposite traffic lane, before the vehicle turns right, the vehicle before turning right possibly collides with another vehicle. Therefore, the lower left region 57Ab is compressed with the low data compression rate. The upper region 58A mostly includes the traffic lane where the vehicle which turned right is travelling and a zone other than the traffic lane. On the traffic lane where the vehicle which turned right is travelling, it is unlikely that the vehicle collides with another vehicle. Therefore, the upper region 58A is compressed with the high data compression rate. The lower center region 57Ac mostly includes the traffic lane where the vehicle which turned right is travelling. On the traffic lane where the vehicle which turned right is travelling, it is unlikely that the vehicle collides with another vehicle. Therefore, the lower center 57Ac is compressed with the high data compression rate.

Turning-Right Stage 3

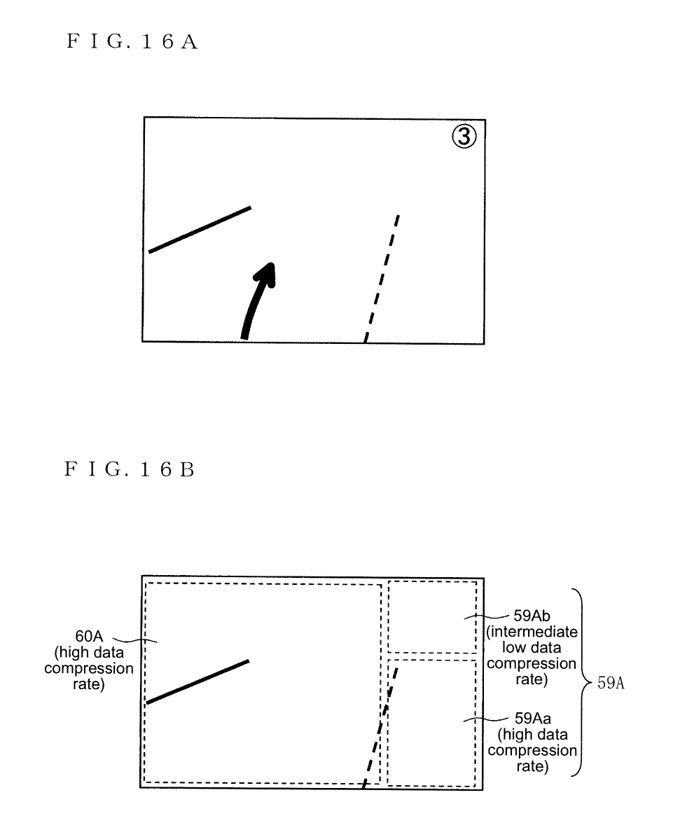

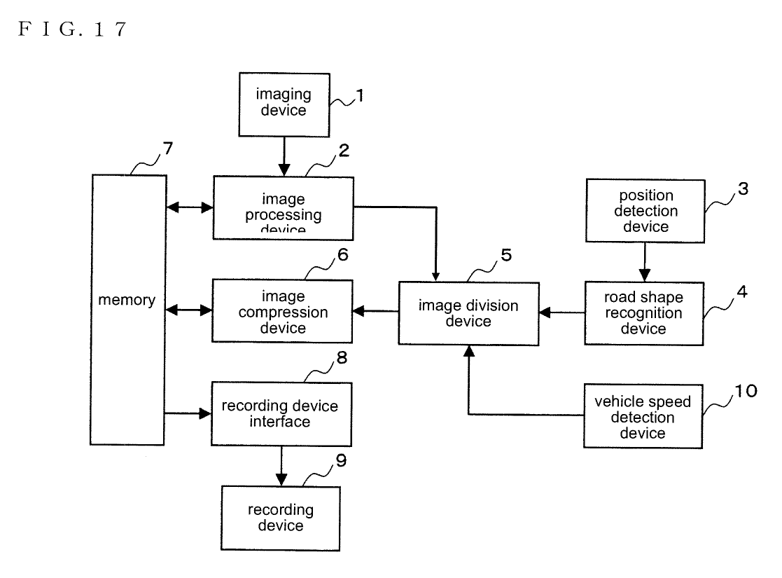

Recognizing that the current travelling progress of the vehicle as a turning-right stage 3 (ending stage) illustrated in FIG. 16A, the display screen is divided into a right region 59A and a left region 60A, and the right region 59A is further divided into a right lower region 59Aa and a right upper region 59Ab as illustrated in FIG. 16B. The right lower region 59Aa mostly includes the opposite traffic lane near the vehicle after the vehicle turned right (hereinafter, called near opposite traffic lane). On the near opposite traffic lane after the vehicle turned right, the vehicle possibly collides with another oncoming vehicle shortly. Therefore, the right lower region 59Aa is compressed with the low data compression rate. The right upper region 59Ab mostly includes the opposite traffic lane distant from the vehicle as compared to the near opposite traffic lane after the vehicle turned right (hereinafter, called distant opposite traffic lane). The distant opposite traffic lane includes some possibility of collision with another oncoming vehicle, however, is unlikely undergo any accident shortly because of its distance from the vehicle. Therefore, the right upper region 59Ab is compressed with the intermediate data compression rate. The left region 60A mostly includes the traffic lane where the vehicle which turned right is travelling. On the traffic lane where the vehicle which turned right is travelling, the vehicle is unlikely to collide with any oncoming vehicle. Therefore, the left region 60A is compressed with the high data compression rate.

According to the present exemplary embodiment, the surrounding image data is divided into different regions so that the data compression rate is differently set for the respective regions. Any parts of significance in the surrounding image data is compressed such that a high image quality is obtained, but the data compression rate is increased for any other parts less significant so that the compression coding amount is reduced. As a result, the relationship of trade-off between the image quality and recording time can be dissolved.

### Exemplary Embodiment 2

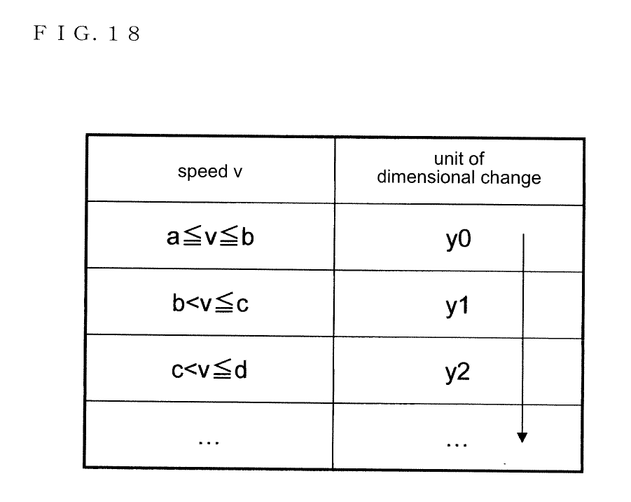

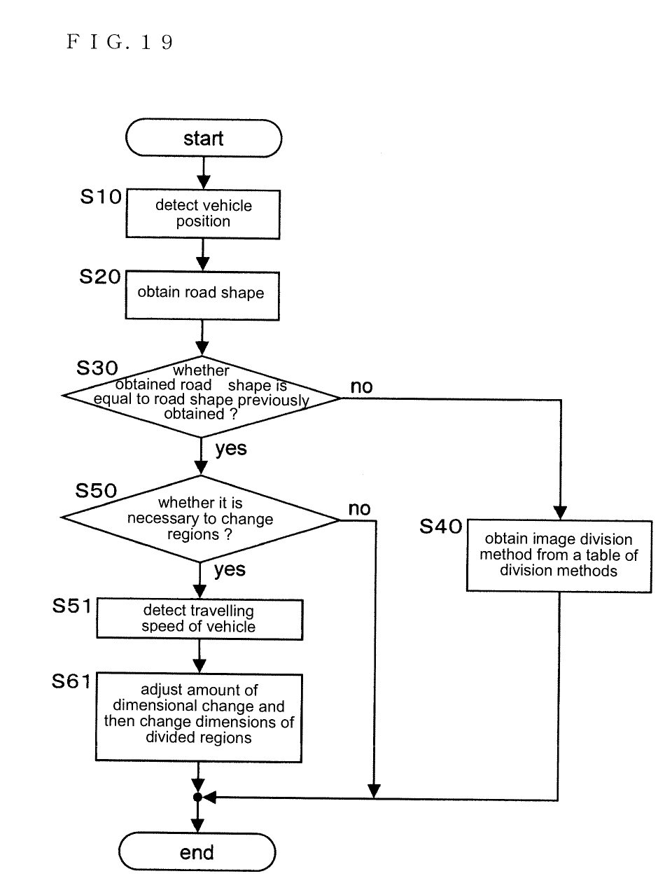

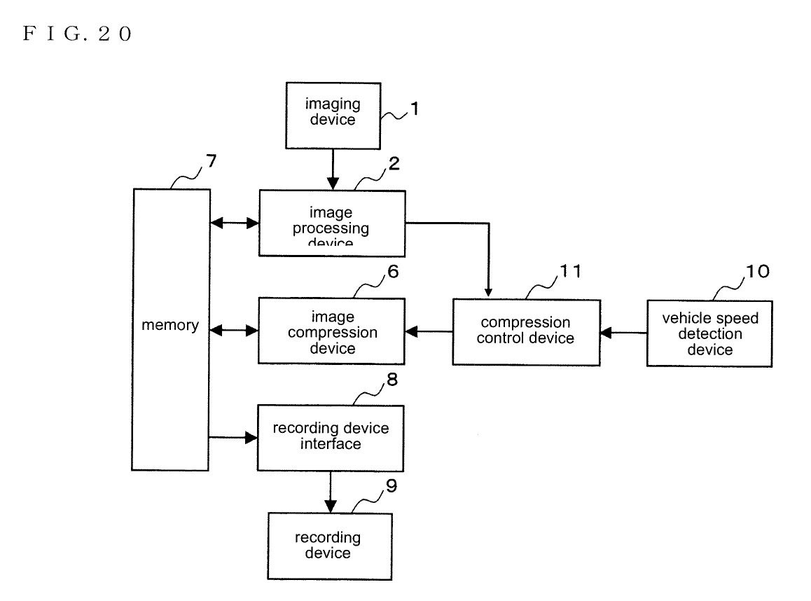

FIG. 17 is a block diagram illustrating a structural characteristic of a vehicle-mounted image recording apparatus according to an exemplary embodiment 2 of the present invention. The same reference symbols illustrated in FIG. 17 as those of FIG. 1 according to the exemplary embodiment 1 denote the same structural elements. The present exemplary embodiment is technically characterized in that a vehicle speed detection device 10 configured to detect the travelling speed of the vehicle is further provided in the structure according to the exemplary embodiment 1. The image division device 5 is configured to divide the surrounding image data based on the recognition result of the road shape recognition device 4 and a detection result of the vehicle speed detection device 10 and differently allocate the data compression rate suitable for each of the divided regions. The travelling speed of the vehicle detected by the vehicle speed detection device 10 is transmitted to the image division device 5 and used to change the unit of dimensional change when the divided regions are dimensionally changed because the road shape more rapidly changes as the vehicle speed is higher, making it necessary to more rapidly change the dimensions of the divided regions as the vehicle speed is increased. The unit of dimensional change is preferably set depending on the travelling speed as illustrated in FIG. 18. The rest of the structural elements are similar to those according to the exemplary embodiment 1, therefore, will not be described again.

FIG. 19 is a flow chart illustrating a flow of processing steps carried out by an image compressing apparatus according to the exemplary embodiment 2. In the flow chart of FIG. 2 according to the exemplary embodiment 1, Step S51 where the vehicle speed is obtained is further included. In Step S51, the vehicle speed detection device 10 detects the vehicle travelling speed. In Step S61, the image division device 5 adjusts the amount of dimensional change in each of the divided regions depending on the detected travelling speed, and then dimensionally changes the divided regions. The present exemplary embodiment can more precisely divide the surrounding image data.

### Exemplary Embodiment 3

The rate of accident occurrence is associated with the driving conditions of the vehicle as well as the road shape. An exemplary embodiment 3 of the present invention focuses on a travelling speed of the vehicle among the driving conditions of the vehicle. An accident is less likely to occur when the vehicle is driven really slow but is more likely to occur when the vehicle increases its speed to run faster. Therefore, the surrounding image data is preferably recorded with a high image quality when the vehicle is travelling at a high speed.

FIG. 20 is a block diagram illustrating a structural characteristic of a vehicle-mounted image recording apparatus according to the exemplary embodiment 3. The vehicle-mounted image recording apparatus has an imaging device 1 configured to capture surrounding images of the vehicle, an image processing device 2 configured to image-process data of the surrounding images outputted from the imaging device 1, a vehicle speed detection device 10 configured to detect the travelling speed of the vehicle, a compression control device 11 configured to set the data compression rate and the frame rate based on the detection result obtained by the vehicle speed detection device 10, an image compression device 6 configured to compress the surrounding image data processed by the image processing device 2 based on the rates set by the compression control device 11, a memory 7 configured to temporarily store therein the surrounding image data and compressed data, a recording device interface 8 configured to record the compressed data stored in the memory 7 in a recording device 9, and the recording device 9 used to record the compressed data.

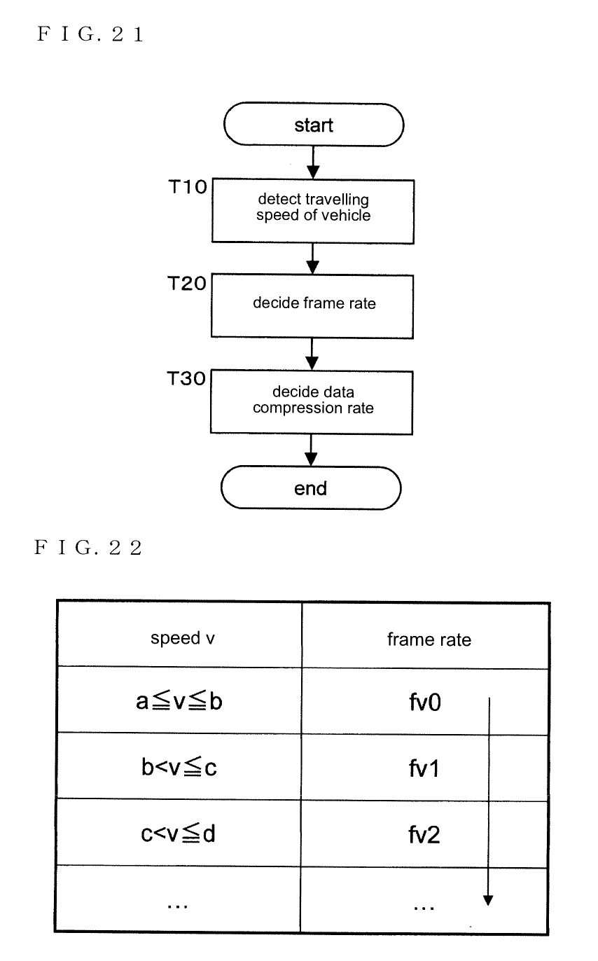

FIG. 21 is a flow chart illustrating a flow of processing steps carried out by an image compressing apparatus according to the exemplary embodiment 3.

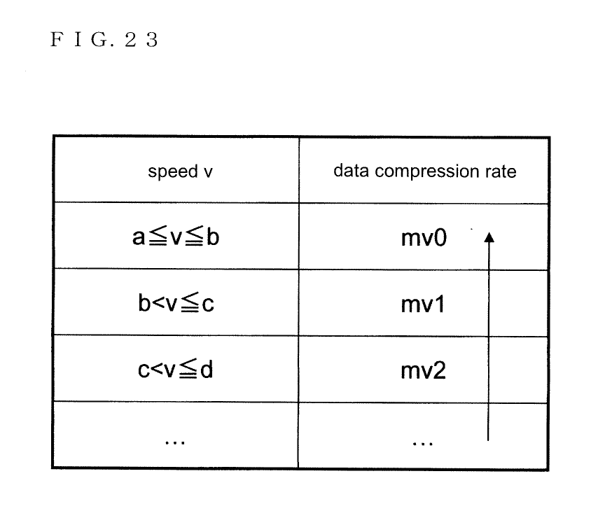

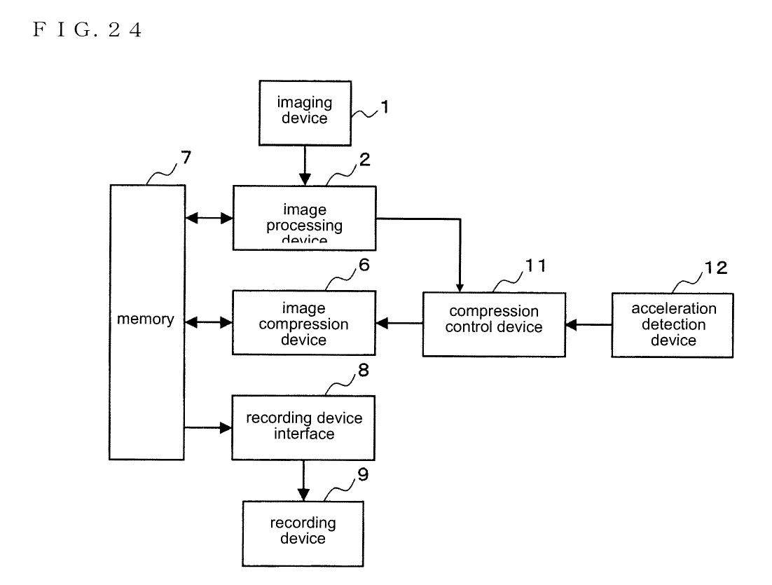

In Step T10, the vehicle speed detection device 10 detects the vehicle travelling speed. In Step T20, the compression control device 11 obtains the frame rate based on the detected travelling speed of the vehicle obtained by the vehicle speed detection device 10 from a table of frame rates illustrated in FIG. 22. The frame rates recited therein have the numeral relationship of fv0<fv1<fv2.

In Step T30, the compression control device 11 obtains the data compression rate based on the detected travelling speed of the vehicle obtained by the vehicle speed detection device 1 from a table of data compression rates illustrated in FIG. 23. The data compression rates recited therein have the numeral relationship of mv0>mv1>mv2. Based on the decided data compression rate and frame rate, the surrounding image data is compressed into codes by the image compression device 6.

According to the present invention, the frame rate is lowered and the data compression rate is elevated, or the frame rate is lowered or the data compression rate is elevated when the vehicle is traveling at a low speed to reduce the compression coding amount of the surrounding image data and thereby succeed in long-hour recording. The frame rate is elevated and the data compression rate is lowered, or the frame rate is elevated or the data compression rate is lowered when the vehicle is traveling at a high speed to improve the image quality of the surrounding image data. As a result, an accident, if happened, can be closely analyzed.

### Exemplary Embodiment 4

An exemplary embodiment 4 of the present invention focuses on a degree of acceleration of the vehicle among the driving conditions of the vehicle. An accident is more likely to occur when the vehicle suddenly starts, comes to a sudden stop, is suddenly accelerated, or is turning a sharp curve than when the vehicle is running at a constant speed. Therefore, the surrounding image data is preferably recorded with a high image quality when a large acceleration is applied to the vehicle.

FIG. 24 is a block diagram illustrating a structural characteristic of a vehicle-mounted image recording apparatus according to the exemplary embodiment 4. The same reference symbols illustrated in FIG. 24 as those of FIG. 20 according to the exemplary embodiment 3 denote the same structural elements. The present exemplary embodiment is technically characterized in that a degree of acceleration detection device 12 configured to detect the degree of acceleration of the vehicle is provided in place of the vehicle speed detection device 10. The compression control device 11 is configured to set the data compression rate and the frame rate based on the degree of acceleration detected by the degree of acceleration detection device 12. The rest of the structural elements are similar to those according to the exemplary embodiment 3, therefore, will not be described again.

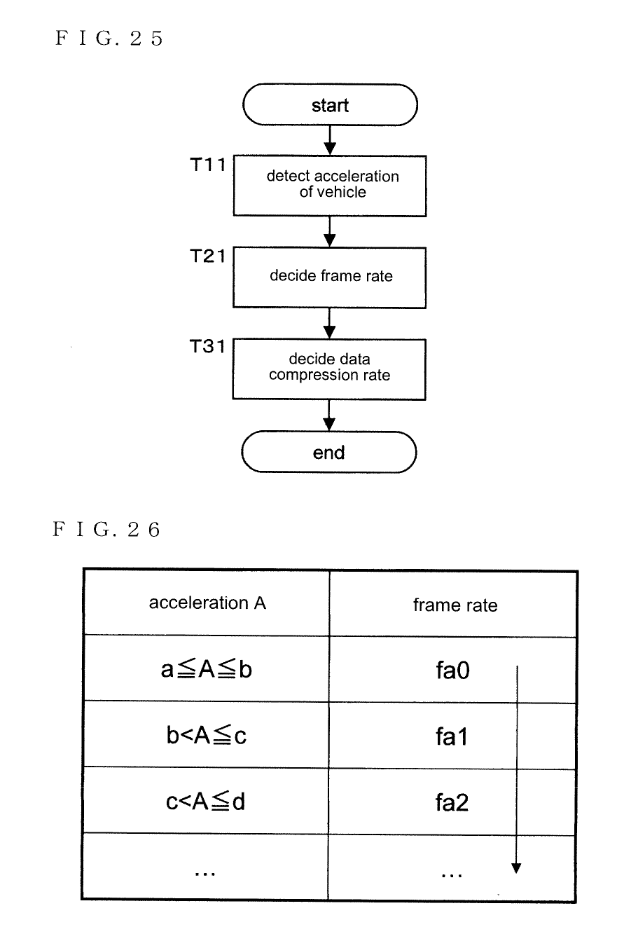

FIG. 25 is a flow chart illustrating a flow of processing steps carried out by an image compressing apparatus according to the exemplary embodiment 4. In Step T11, the degree of acceleration detection device 12 detects the degree of acceleration of the vehicle. In Step T21, the compression control device 11 obtains the frame rate suitable for the degree of acceleration obtained by the degree of acceleration detection device 12 from a table of frame rates illustrated in FIG. 26. The frame rates have the numeral relationship of fa0<fa1<fa2.

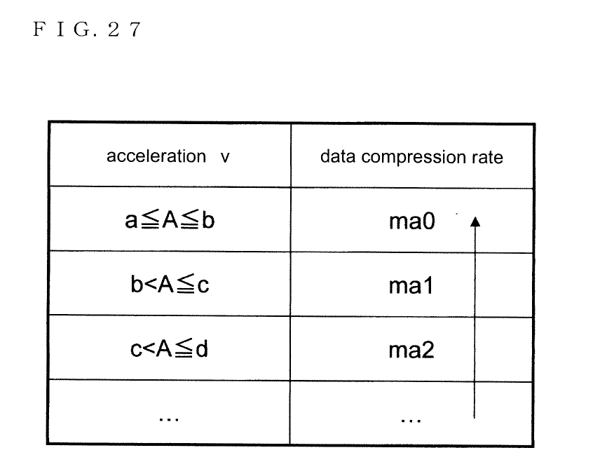

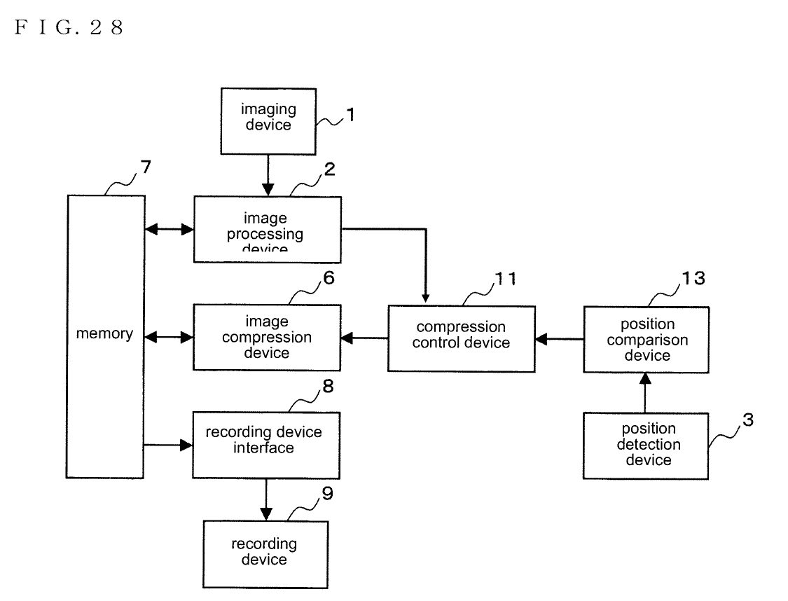

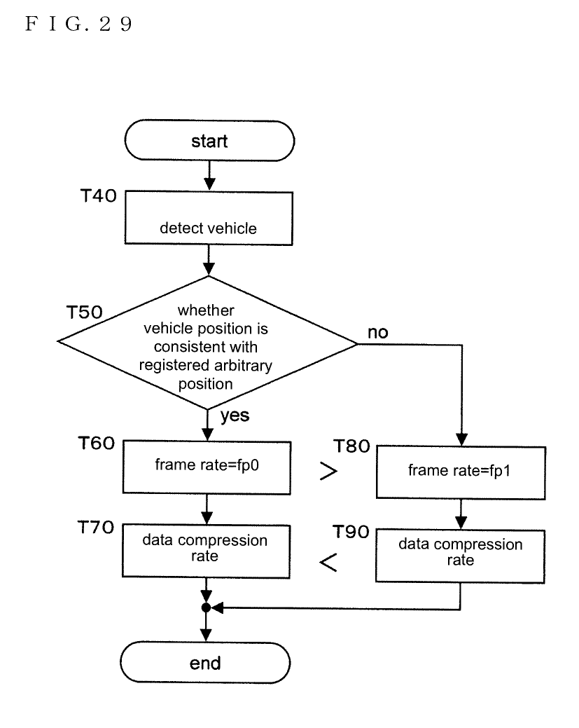

In Step T31, the compression control device 11 obtains the data compression rate suitable for the degree of acceleration obtained by the degree of acceleration detection device 12 from a table of data compression rates illustrated in FIG. 27. The data compression rates have the numeral relationship of ma0>ma1>ma2. The image compression device 6 compresses the surrounding image data based on the obtained data compression rate and frame rate.

According to the present invention, the frame rate is lowered and the data compression rate is elevated, or the frame rate is lowered or the data compression rate is elevated in the case of a small acceleration to reduce the compression coding amount of the surrounding image data and thereby succeed in long-hour recording. The frame rate is elevated and the data compression rate is lowered, or the frame rate is elevated or the data compression rate is lowered in the case of a large acceleration to improve the image quality of the surrounding image data. As a result, an accident, if happened, can be closely analyzed.

### Exemplary Embodiment 5

An exemplary embodiment 5 of the present invention focuses on a current position of the vehicle among the driving conditions of the vehicle. An accident is more likely to occur in any high accident spots. Therefore, the surrounding image data is preferably recorded with a high image quality when the vehicle is travelling through any high accident spots.

FIG. 28 is a block diagram illustrating a structural characteristic of a vehicle-mounted image recording apparatus according to the exemplary embodiment 5. The same reference symbols illustrated in FIG. 28 as those of FIG. 20 according to the exemplary embodiment 3 denote the same structural elements. The present exemplary embodiment is technically characterized in that a position detection device 3 and a position comparison device 13 are provided in place of the vehicle speed detection device 10. The position comparison device 13 compares a position obtained by the position detection device 3 to a preregistered arbitrary position (position of a high accident spot) and outputs a result of the comparison to the compression control device 11. The compression control device 11 is configured to set the data compression rate and the frame rate based on the comparison result transmitted from the position comparison device 13. The rest of the structural elements are similar to those according to the exemplary embodiment 3, therefore, will not be described again.

FIG. 29 is a flow chart illustrating a flow of processing steps carried out by an image compressing apparatus according to the exemplary embodiment 5. In Step T40, the position detection device 3 detects the vehicle position. In Step T50, the position comparison device 13 compares the vehicle position obtained from the position detection device 3 to the preregistered arbitrary position. When the two positions are consistent with each other according to the comparison result, the compression control device 11 sets the frame rate to fp0 in Step T60, and sets the data compression rate to mp0 in Step T70. When the two positions are inconsistent with each other according to the comparison result, the compression control device 11 sets the frame rate to fp1 in Step T80, and sets the data compression rate to mp1 in Step T90. The respective rates have the numeral relationships of fp0>fp1, and mp0<mp1. Then, the image compression device 6 compresses the surrounding image data based on the decided data compression rate and frame rate.

According to the present invention, the frame rate is lowered and the data compression rate is elevated, or the frame rate is lowered or the data compression rate is elevated when the vehicle is not travelling through the preregistered high accident spot (arbitrary position) to reduce the compression coding amount of the surrounding image data and thereby succeed in long-hour recording. The frame rate is elevated and the data compression rate is lowered, or the frame rate is elevated or the data compression rate is lowered when the vehicle is travelling through the preregistered high accident spot (arbitrary position) to improve the image quality of the surrounding image data. As a result, an accident, if happened, can be closely analyzed.

### Exemplary Embodiment 6

An exemplary embodiment 6 of the present invention focuses on information on a traveling route of the vehicle among the driving conditions of the vehicle. An accident is more likely to occur when the vehicle is running on any inexperienced roads than when the vehicle is running on a known road where the vehicle runs on a daily basis. Therefore, the surrounding image data is preferably recorded with a high image quality when the vehicle is running on any inexperienced roads.

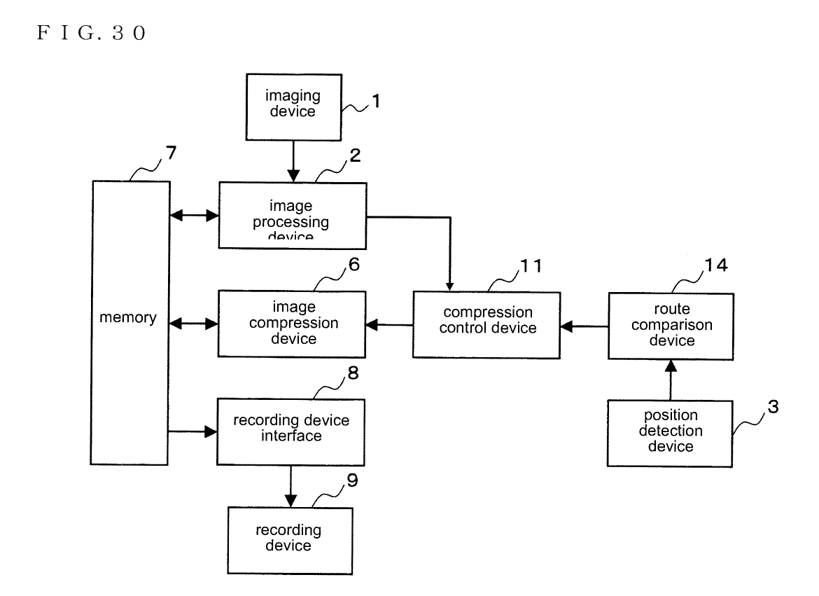

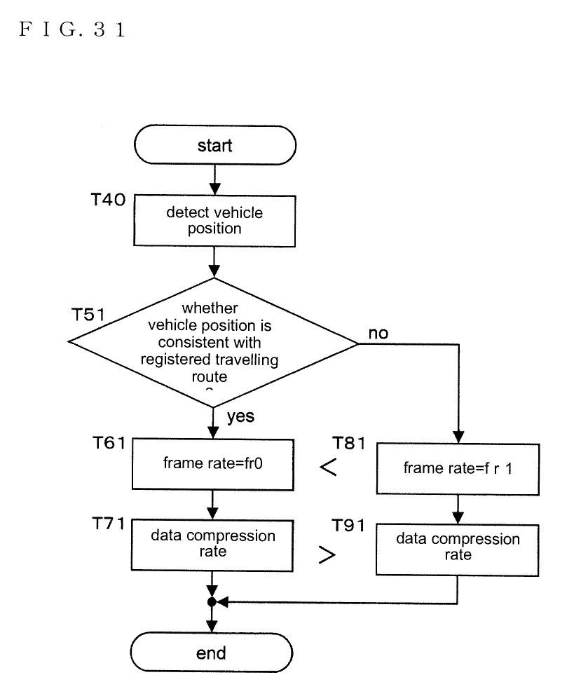

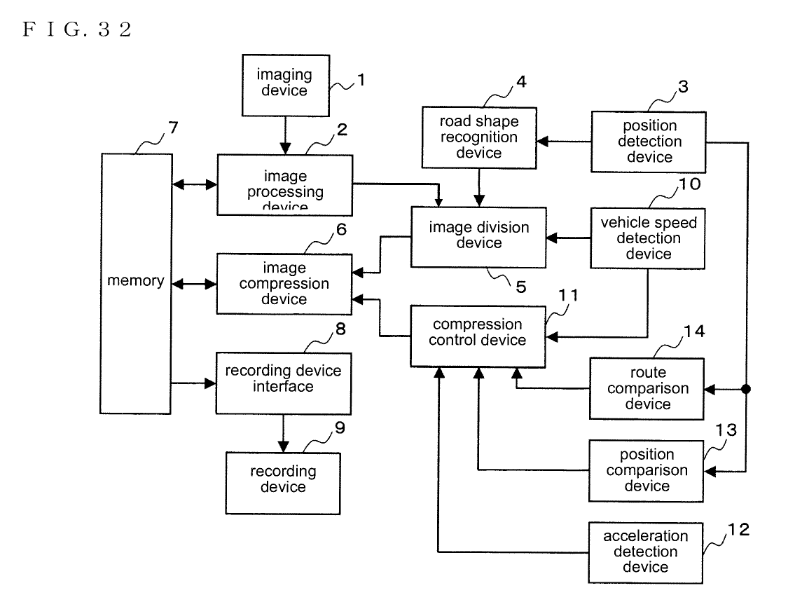

FIG. 30 is a block diagram illustrating a structural characteristic of a vehicle-mounted image recording apparatus according to the exemplary embodiment 6. The same reference symbols illustrated in FIG. 30 as those of FIG. 28 according to the exemplary embodiment 5 denote the same structural elements. The present exemplary embodiment is technically characterized in that a route comparison device 14 is provided in place of the position comparison device 13. The route comparison device 14 compares a position obtained by the position detection device 3 to a preregistered traveling route and outputs a result of the comparison to the compression control device 11. The compression control device 11 is configured to set the data compression rate and the frame rate based on the comparison result transmitted from the route comparison device 14. The rest of the structural elements are similar to those according to the exemplary embodiment 5, therefore, will not be described again.

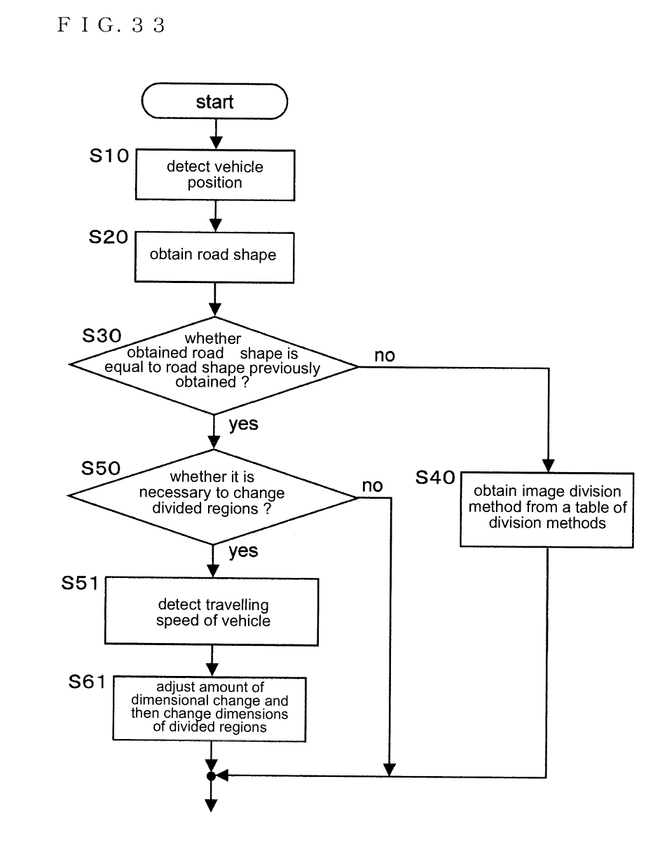

FIG. 31 is a flow chart illustrating a flow of processing steps carried out by an image compressing apparatus according to the exemplary embodiment 6. In Step T40, the position detection device 3 detects the position of the vehicle. In Step T51, the route comparison device 14 compares the position of the vehicle or the travelling route figured out based on the obtained position of the vehicle received from the position detection device 3 to the preregistered travelling route. When the position or the travelling route is consistent with the preregistered information according to the comparison result, the compression control device 11 sets the frame rate to fr0 in Step T61, and sets the data compression rate to mr0 in Step T71. When they are inconsistent with each other according to the comparison result, the compression control device 11 sets the frame rate to fr1 in Step T81, and sets the data compression rate to mr1 in Step T91. The respective rates have the numeral relationships of fr0<fr1, and mr0>mr1. Then, the image compression device 6 compresses the surrounding image data based on the decided data compression rate and frame rate.

According to the present invention, the frame rate is lowered and the data compression rate is elevated, or the frame rate is lowered or the data compression rate is elevated when the vehicle is travelling on the preregistered travelling route to reduce the compression coding amount of the surrounding image data and thereby succeed in long-hour recording. The frame rate is elevated and the data compression rate is lowered, or the frame rate is elevated or the data compression rate is lowered when the vehicle is not travelling on the preregistered travelling route to improve the image quality of the surrounding image data. As a result, an accident, if happened, can be closely analyzed.

### Exemplary Embodiment 7

An exemplary embodiment 7 of the present invention recites a vehicle-mounted image recording apparatus wherein the exemplary embodiments 1-6 are combined.

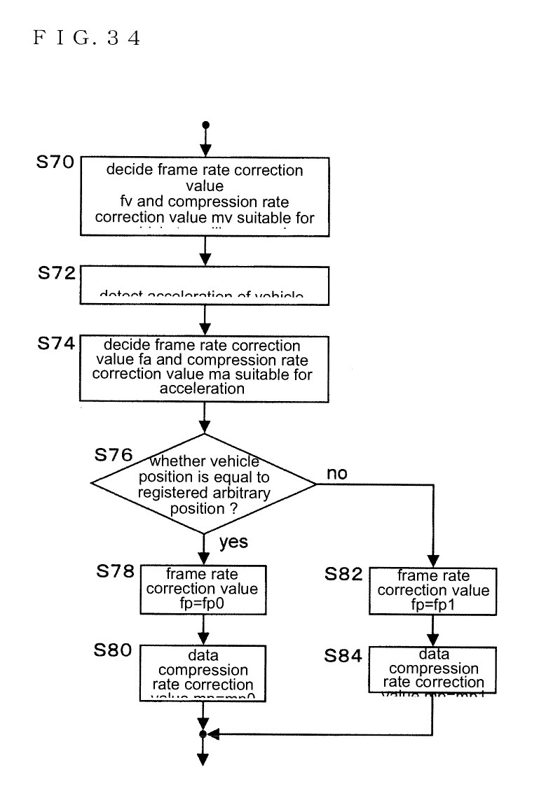

FIG. 32 is a block diagram illustrating a structural characteristic of a vehicle-mounted image recording apparatus according to the exemplary embodiment 7. The vehicle-mounted image recording apparatus has an imaging device 1, an image processing device 2, a position detection device 3, a memory 7, a recording device interface 8, a recording device 9, a vehicle speed detection device 10 configured to detect the travelling speed of the vehicle, a road shape recognition device 4, an image division device 5 configured to divide the surrounding image data based on the results obtained from the rod shape recognition device 4 and the vehicle speed detection device 10 and differently allocate the data compression rate suitable for each of the divided regions, a degree of acceleration detection device 12 configured to detect the degree of acceleration of the vehicle, a position comparison device 13 configured to compare the position of the vehicle detected by the position detection device 3 to the preregistered arbitrary position, a route comparison device 14 configured to compare the position detected by the position detection device 3 or the travelling route figured out based on the detected position to the preregistered travelling route, a compression control device 11 configured to decide the data compression rate and the frame rate based on the results respectively obtained from the vehicle speed detection device 10, acceleration detection device 12, position comparison device 13, and route comparison device 14, and an image compression device 6 configured to compress the surrounding image data processed by the image processing device 2 based on a result obtained by the compression control device 11.

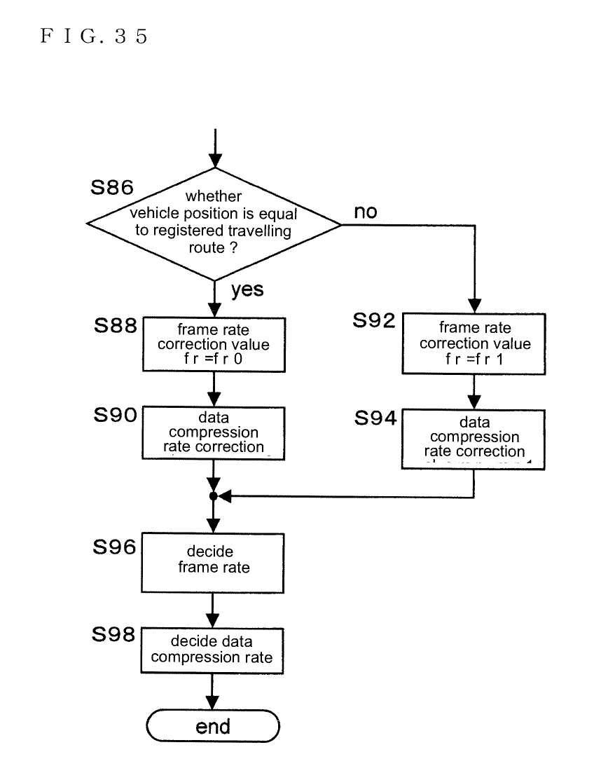

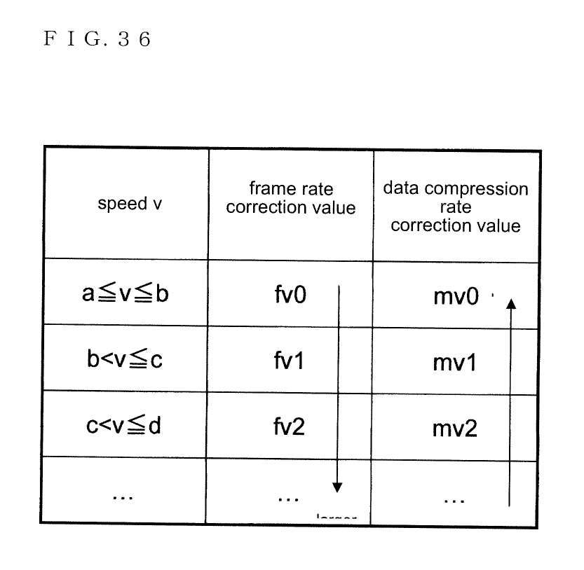

FIGS. 33, 34, and 35 are flow charts each illustrating a flow of processing steps carried out by an image compressing apparatus according to the exemplary embodiment 7. In Step S10 illustrated in FIG. 33, the position detection device 3 detects the position of the vehicle. In Step S20, the road shape recognition device 4 recognizes the shape of the road where the vehicle is currently traveling based on the obtained information. In Step S30, the road shape recognition device 4 determines whether the vehicle position information obtained then is equal to the road shape obtained previously, and performs the different processes depending on a determination result thereby obtained. The processing flow proceeds to Step S40 when the two road shapes are equal to each other according to the determination result, while proceeding to Step S50 when the two road shapes are different according to the determination result.

In Step S40, the image division device 5 obtains the image division method suitable for the road shape obtained then from the table of image division methods. In Step S50, the image division device 5 determines whether the divided regions should be dimensionally changed. When the image division device 5 determined that the divided regions should be dimensionally changed, the processing flow proceeds to Step S51. In Step S51, the vehicle speed detection device 10 detects the travelling speed of the vehicle. In Step S61, the image division device 5 adjusts the amount of dimensional change in each of the divided regions depending on the detected travelling speed, and changes the dimensions of the respective divided regions. As illustrated in FIG. 18, the unit of dimensional change is preferably set based on the travelling speed.

As soon as Step S51 is over, a reference value fb of the frame rate and a reference value mb of the data compression rate are decided. In a processing flow described below, a frame rate correction value and a data compression rate correction value are decided based on the travelling speed, acceleration, position, and travelling route of the vehicle. Then, the data compression rate and the frame rate to be used for the data compression are decided based on the flow chart illustrated in FIG. 34.

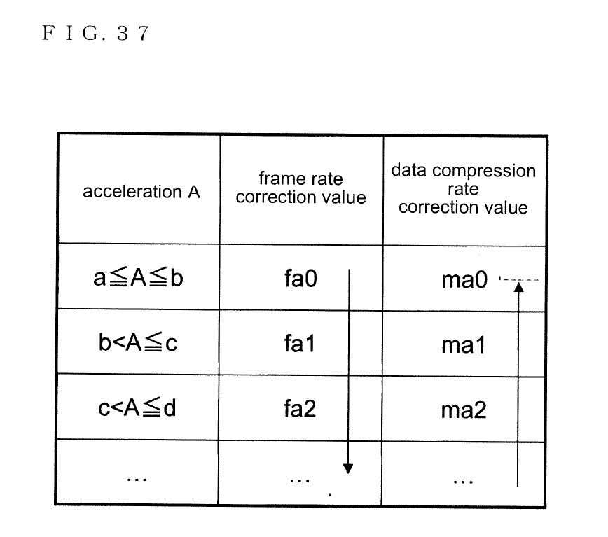

In Step S70, a frame rate correction value fv and a data compression rate correction value my suitable for the travelling speed of the vehicle are selected from a table illustrated in FIG. 36. In Step S72, the degree of acceleration of the vehicle is obtained from the degree of acceleration detection device 12. In Step S74, a frame rate correction value fa and a data compression rate correction value ma suitable for the obtained acceleration of the vehicle are selected from a table illustrated in FIG. 37.

In Step S76, the position of the vehicle detected by the position detection device 3 is compared to the preregistered arbitrary position (for example, position of a high accident spot). When the two positions are consistent with each other, a frame rate correction value fp is decided as fp=fp0 in Step S78, and a data compression rate correction value mp is decided as mp=mp0 in Step S80.

When the vehicle position is inconsistent with the preregistered arbitrary position in Step S76, the frame rate correction value fp is decided as fp=fp1 in Step S82, and the data compression rate correction value mp is decided as mp=mp1 in Step S84.

In Step S86, the vehicle position detected by the position detection device 3 is compared to the preregistered travelling route. When the vehicle position is consistent with the information, a frame rate correction value fr is decided as fr=fr0 in Step S88, and a data compression rate correction value mr is decided as mr=mr0 in Step S90. When the vehicle position is inconsistent with the information in Step S86, the frame rate correction value fr is decided as fr=fr1 in Step S92, and the data compression rate correction value mr is decided as mr=mr1 in Step S94.

In Step S96, a frame rate f is calculated in the following formula based on the frame rate reference value fb and the frame rate correction values fv, fa, fp, and fr.

f=fb+fv+fa+fp+fr

In Step S98, a data compression rate m is calculated in the following formula based on the data compression rate reference value mb and the data compression rate correction values my, ma, mp, and mr.

m=mb+my+ma+mp+mr

Then, the surrounding image data is compressed by the image compression device 6 based on the frame rate f and the data compression rate m thus calculated.

According to the present exemplary embodiment, various frame rates and data compression rates suitable for the driving conditions such as the vehicle position, travelling speed, and acceleration can be employed to compress the surrounding image data into codes.

The present exemplary embodiment includes all of the technical characteristics according to the exemplary embodiments 1-6, but may include only some of the exemplary embodiments variously combined.

### INDUSTRIAL APPLICABILITY

The technology provided by the present exemplary embodiment dissolves the relationship of trade-off between an image quality and recording time, thereby succeeding in long-hour recording while attaining a high image quality. The technology is applicable to, for example, drive recorders.

### DESCRIPTION OF REFERENCE SYMBOLS

1 imaging device
2 image processing device
3 position detection device
4 road shape recognition device
5 image division device
6 image compression device
7 memory
8 recording device interface
9 recording device
10 vehicle speed detection device
11 compression control device
12 acceleration detection device
13 position comparison device
14 route comparison device

What is claimed is:

1. An image compressing apparatus, comprising:
a position detection device configured to detect a position of a currently travelling vehicle equipped with the apparatus;
a road shape recognition device configured to check the position of the currently travelling vehicle detected by the position detection device with a map information so that a road shape at each travelling spot of the currently travelling vehicle is recognized;
an image division device configured to divide a display screen of surrounding image data of the currently travelling vehicle into a plurality of divided regions depending on the road shape and set a data compression rate suitable for the road shape in each of the plurality of divided regions; and
an image compression device configured to obtain the surrounding image data and compress the surrounding image data in each of the plurality of divided regions into codes based on the data compression rate set for each of the divided regions.

2. The image compressing apparatus as claimed in claim 1, wherein
the road shape recognition device stores therein in advance the map information including the road shape at each travelling spot, and the road shape recognition device checks the position of the currently travelling vehicle with the map information to thereby recognize the road shape at each travelling spot of the currently travelling vehicle.

3. The image compressing apparatus as claimed in claim 1, wherein
the road shape recognition device recognizes a travelling progress of the currently travelling vehicle at each travelling spot based on a change of the road shape at each travelling spot, and
the image division device adjusts the divided regions and the data compression rate depending on the road shape and the travelling progress.

4. The image compressing apparatus as claimed in claim 3, wherein
the position detection device further detects a direction of the currently travelling vehicle, and
the road shape recognition device recognizes the travelling progress of the currently travelling vehicle at each travelling spot based on the road shape and the direction of the currently travelling vehicle.

5. The image compressing apparatus as claimed in claim 3, wherein
the image division device adjusts relative dimensions of the plurality of divided regions on the display screen of the surrounding image data depending on the travelling progress.

6. The image compressing apparatus as claimed in claim 5, further comprising a vehicle speed detection device configured to detect a travelling speed of the currently travelling vehicle, wherein
the image division device continuously changes the relative dimensions of the plurality of divided regions on the display screen and changes an amount of dimensional change per unit time in each of the divided regions depending on the travelling speed

7. An image compressing apparatus, comprising:
an image compression device configured to obtain surrounding image data of a currently travelling vehicle equipped with the apparatus and compress the obtained surrounding image data into codes;
a speed detection device configured to detect a travelling speed of the vehicle; and
a compression control device configured to perform one or both of a process to set a data compression rate of the surrounding image data depending on the travelling speed and a process to set a frame rate of the surrounding image data depending on the travelling speed, wherein
the image compression device compresses the surrounding image data into codes based on any of the data compression rate, the frame rate, and the data compression rate and the frame rate both respectively set by the compression control device.

8. An image compressing apparatus, comprising:
an image compression device configured to obtain surrounding image data of a currently travelling vehicle equipped with the apparatus and compress the obtained surrounding image data into codes;
a degree of acceleration detection device configured to detect a degree of acceleration of the vehicle; and
a compression control device configured to perform one or both of a process to set a data compression rate of the surrounding depending on the degree of acceleration and a process to set a frame rate of the surrounding depending on the degree of acceleration, wherein
the image compression device compresses the surrounding image data into codes based on any of the data compression rate, the frame rate, and the data compression rate and the frame rate both respectively set by the compression control device.

9. An image compressing apparatus, comprising:
an image compression device configured to obtain surrounding image data of a currently travelling vehicle equipped with the apparatus and compress the obtained surrounding image data into codes;
a position detection device configured to detect a position of the currently travelling vehicle;
a position comparison device configured to preregister an arbitrary position and determine whether the position of the currently travelling vehicle detected by the position detection device is equal to the preregistered arbitrary position; and
a compression control device configured to perform one or both of an adjustment process to decrease a data compression rate of the surrounding image data and an adjustment process to increase a frame rate of the surrounding image data when the position comparison device determines that the position of the currently travelling vehicle is equal to the preregistered arbitrary position, wherein
the image compression device compresses the surrounding image data into codes based on any of the data compression rate, the frame rate, and the data compression rate and the frame rate both respectively adjusted by the compression control device.

10. An image compressing apparatus, comprising:
an image compression device configured to obtain surrounding image data of a currently travelling vehicle equipped with the apparatus and compress the obtained surrounding image data into codes;
a position detection device configured to detect a position of the currently travelling vehicle;
a route comparison device configured to preregister an arbitrary travelling route and determine whether the position of the currently travelling vehicle detected by the position detection device is deviating from the preregistered arbitrary travelling route; and
a compression control device configured to perform one or both of an adjustment process to decrease a data compression rate of the surrounding image data and an adjustment process to increase a frame rate of the surrounding image data when the route comparison device determines that the position of the currently travelling vehicle is deviating from the preregistered arbitrary travelling route, wherein
the image compression device compresses the surrounding image data into codes based on any of the data compression rate, the frame rate, and the data compression rate and the frame rate both respectively adjusted by the compression control device.

11. A vehicle-mounted image recording apparatus, comprising:
an imaging device configured to obtain surrounding image data of a currently travelling vehicle equipped with the apparatus;
an image processing device configured to image-process the surrounding image data outputted from the imaging device;
the image compression device as claimed in claim 1 configured to compress the surrounding image data image-processed by the image processing device; and
a recording device configured to record therein the surrounding image data compressed by the image compression device.

12. An image compressing method, comprising:
a first step for detecting at predetermined intervals a position of a currently travelling vehicle to which the method is applied;
a second step for checking the position of the currently travelling vehicle detected in the first step with a map information so that a road shape at each travelling spot of the currently travelling vehicle is recognized;
a third step for determining whether a first road shape recognized then is equal to a second road shape previously recognized;
a fourth step for dividing a display screen of surrounding image data of the currently travelling vehicle into a plurality of divided regions depending on the first road shape when the third step determines that the first road shape is not equal to the second road shape, the fourth step further setting a data compression rate suitable for the first road shape in each of a plurality of first divided regions in the plurality of divided regions set on the display screen;
a fifth step for determining whether a relative dimension on the display screen of a second divided region previously set on the display screen depending on the second road shape should be adjusted when the third step determines that the first road shape is equal to the second road shape;
a sixth step for recognizing a travelling progress of the currently travelling vehicle then based on the first road shape and adjusting the relative dimension on the display screen of the second divided region based on the travelling progress when the fifth step determines that the relative dimension should be adjusted; and
a seventh step for compressing the surrounding image data into codes based on the data compression rate set for the plurality of first divided regions or the second divided region in each of the plurality of first divided regions or the second divided region.

13. The image compressing method as claimed in claim 12, further comprising an eighth step for detecting a travelling speed of the currently travelling vehicle, wherein
the sixth step continuously changes the relative dimensions of the plurality of divided regions on the display screen and changes an amount of dimensional change per unit time in each of the divided regions depending on the travelling speed.

14. An image compressing method, comprising:
a first step for detecting a travelling speed of a currently travelling vehicle to which the method is applied;
a second step for setting one of a data compression rate and a frame rate of surrounding image data of the currently travelling vehicle depending on the travelling speed detected in the first step; and
a third step for obtaining the surrounding image data and compressing the obtained surrounding image data into codes based on one of the data compression rate and the frame rate set in the second step.

15. An image compressing method, comprising:
a first step for detecting a degree of acceleration of a currently travelling vehicle to which the method is applied;
a second step for setting one of a data compression rate and a frame rate of surrounding image data of the currently travelling vehicle depending on the degree of acceleration detected in the first step; and
a third step for obtaining the surrounding image data and compressing the obtained surrounding image data into codes based on one of the data compression rate and the frame rate set in the second step.

16. An image compressing method, comprising:
a first step for detecting a position of a currently travelling vehicle to which the method is applied;
a second step for preregistering an arbitrary position and determining whether the position of the currently travelling vehicle detected in the first step is equal to the preregistered arbitrary position;
a third step for performing one or both of an adjustment process to decrease a data compression rate of surrounding image data of the currently travelling vehicle and an adjustment process to increase a frame rate of the surrounding image data when the second step determines that the position of the currently travelling vehicle is equal to the preregistered arbitrary position; and
a fourth step for obtaining the surrounding image data and compressing the obtained surrounding image data into codes based on any of the data compression rate, the frame rate, and the data compression rate and the frame rate both respectively adjusted in the third step.

17. An image compressing method, comprising
a first step for detecting a position of a currently travelling vehicle to which the method is applied;
a second step for preregistering an arbitrary travelling route and determining whether the position of the currently travelling vehicle detected in the first step is deviating from the preregistered arbitrary travelling route;
a third step for performing one or both of an adjustment process to decrease a data compression rate of surrounding image data of the currently travelling vehicle and an adjustment process to increase a frame rate of the surrounding image data when the second step determines that the position of the currently travelling vehicle is deviating from the preregistered arbitrary travelling route; and
a fourth step for compressing the surrounding image data into codes based on any of the data compression rate, the frame rate, and the data compression rate and the frame rate both respectively adjusted in the third step.
